(19) United States
(12) Patent Application Publication
(10) Pub. No.: US 2024/0123694 A1
(43) Pub. Date: Apr. 18, 2024

(54) NEW REINFORCING MATERIALS BASED ON S- AND Z-TWISTED YARNS FOR THE MANUFACTURE OF COMPOSITE PARTS, METHODS AND USE

(71) Applicant: HEXCEL REINFORCEMENTS, Dagneux (FR)

(72) Inventors: Andréa VIARD, Villemoirieu (FR); Jean-Marc BERAUD, Rives (FR); Jean-Benoît THIEL, La chapelle de la tour (FR); François FORESTELLO, Sermerieu (FR)

(73) Assignee: HEXCEL REINFORCEMENTS SASU, Dagneux (FR)

(21) Appl. No.: 18/547,744

(22) PCT Filed: Mar. 22, 2022
(86) PCT No.: PCT/FR2022/050404

§ 371 Date: Aug. 24, 2023

(30) Foreign Application Priority Data
Mar. 11, 2021 (FR) FR2102409

(51) Int. Cl. B29C 70/20; B29C 70/08; B29C 70/38; B32B 3/18; B32B 5/02; B32B 5/26; D02G 3/02; D02G 3/26; D02G 3/44; D04H 1/4334

(52) U.S. Cl. CPC B29C 70/20; B29C 70/083; B29C 70/382; B32B 3/18; B32B 5/022; B32B 5/265; D02G 3/02; D02G 3/26; D02G 3/441; D02G 3/447; D04H 1/4334; B29K 2277/00; B32B 2307/718; B32B 2307/7375; D10B 2101/12; D10B 2505/02

(57) ABSTRACT

The reinforcing material comprises a unidirectional reinforcing web (2) formed of one or a plurality of carbon yarns (3), associated on at least one of its faces, preferably on each of its faces, with a porous polymeric layer (4, 5), the polymeric portion of the reinforcing material representing from 0.5% to 10% of its total weight and preferably from 2% to 6% of its total weight, characterized in that said carbon yarns (3) are individually twisted having a twist from 3 turns/m to 15 turns/m, preferably from 6 turns/m to 12 turns/m, and comprise at least one S-twist yarn and at least one Z-twist yarn, from a selection according to claim 1.

### TECHNICAL AREA

The present invention relates to the technical field of reinforcing materials, suitable for forming composite parts. More specifically, the invention relates to reinforcing materials suitable for the production of composite parts in association with an injected or infused resin, comprising a unidirectional web made at least in part of a series of individually twisted carbon yarns, having a twist suitable for ensuring the diffusion of the injected or infused resin during production of the composite part.

### PRIOR ART

The manufacture of composite parts or articles, that is, comprising, firstly, one or a plurality of fibrous reinforcements, particularly of the unidirectional fibrous web type, and, secondly, a matrix (which is, usually, mainly of the thermosetting type and can include one or a plurality of thermoplastics) can, for example, be produced by a so-called direct or Liquid Composite Molding (LCM) process. A direct process is defined by the fact that one or a plurality of fibrous reinforcements are used in the “dry” state (that is, without the final matrix), the resin or matrix being used separately, for example, by injection into the mold containing the fibrous reinforcements (Resin Transfer Molding (RTM) process), by infusion through the thickness of the fibrous reinforcements (Liquid Resin Infusion (LRI) process, or Resin Film Infusion (RFI) process), or else by manual coating/impregnation by means of a roller or a brush, on each of the individual layers of fibrous reinforcements, applied successively to the form. Within the scope of manufacturing composite parts, particularly in the field of aeronautics, the mass production rate can be high. For example, for the manufacture of single-aisle aircraft, aeronautics customers want to be able to produce several dozen aircraft per month. Direct processes such as infusion or injection are particularly relevant processes that can meet this requirement.

For RTM, LRI, or RFI processes, it is generally necessary to first produce a fibrous preform or stack in the shape of the desired finished article, and then to impregnate that preform or stack with a resin to form a matrix. The resin is injected or infused by means of a temperature pressure differential, then after all the required amount of resin is contained in the preform, the assembly is brought to a higher temperature to carry out the polymerization/cross-linking cycle and thus resulting in its hardening.

Composite parts used in the automotive, aeronautics, or naval industries in particular are subject to very stringent requirements, particularly in terms of mechanical properties. In order to save fuel and facilitate the maintenance of parts, the aeronautics industry has replaced many metallic materials with lighter composite materials.

The resin that is subsequently associated, in particular by injection or infusion, with the fibrous reinforcements, during the production of the part, can be a thermosetting resin, for example of the epoxy type. In order to make it possible for resin to flow properly through a preform consisting of a stack of various layers of fibrous reinforcements, this resin is, usually, very fluid, for example, with a viscosity on the order of 50 mPas. to 200 mPas., or lower, at the infusion/injection temperature. The major disadvantage of this type of resin is brittleness, after polymerization/cross-linking, which results in low impact resistance of the composite parts produced.

In order to solve this problem, it has been proposed in documents of the prior art, that fibrous reinforcing layers, in particular unidirectional webs of carbons yarns, be associated with porous thermoplastic polymer layers, and in particular with a thermoplastic fiber woven fabric or non-woven material (also referred to as a veil). Such solutions are described in particular in the patent applications or patents EP 1125728, U.S. Pat. No. 6,828,016, WO 00/58083, WO 2007/015706, WO 2006/121961, U.S. Pat. No. 6,503,856, US 2008/7435693, WO 2010/046609, WO 2010/061114 and EP 2,547,816, US 2008/0289743, US 2007/8361262, US 2011/9371604, WO 2011/048340. The addition of this porous thermoplastic layer, in particular of the non-woven type, makes it possible to improve the mechanical properties of the resulting composite parts in the Compression After Impact (CAI) test, a test commonly used to characterize the impact resistance of structures. The use of non-woven materials makes it possible, in particular, to achieve mechanical performances suited to the field of aeronautics.

In order to achieve satisfactory production rates for composite parts, the times for lay-up of the dry reinforcing materials and impregnating or infusing the resin into the stack or preform of dry reinforcing materials obtained should be as short as possible.

In addition, in the field of aeronautics, stresses linked to the electrical environment of the aircraft in flight and on the ground, particularly in the event of lightning, make it necessary to provide a material that meets the high standards in this field.

For this purpose, solutions have been proposed in the prior art to:
increase the permeability of dry reinforcing materials to the liquid resin that is injected or infused;
provide satisfactory transverse electrical conductivity.

The applicant has proposed micro-perforation methods for the previously described materials, which improve the transverse permeability of the material (WO 2010/046609), improve its transverse cohesion, and thus facilitate its processing by automated lay-up (WO 2014/076433), and improve the transverse electrical conductivity of the composite parts produced (WO 2013/160604).

Nevertheless, on an industrial scale, this technique requires special tooling to make the micro-perforations and results in a complex lay-up operation for micro-perforated materials, especially for those having high grammages.

Further, the micro-perforation technique presents difficulties in adaptation for the manufacture of dry reinforcing materials made of high grammage carbon yarn unidirectional webs. Indeed, the amount of polymeric binder present in the woven fabric or non-woven material is generally insufficient to i. obtain proper cohesion of the dry reinforcing material, necessary for satisfactory lay-up, and ii. have a micro-perforation resulting in high permeability. However, the manufacture of dry reinforcing materials made of unidirectional high grammage carbon yarn webs is desirable, as such materials make it possible to increase the weight of dry reinforcing material laid up per unit of time.

To increase the internal cohesion of the unidirectional webs present in the reinforcing material, in WO 2012/164014 the applicant proposed to use polymeric powder, by causing it to penetrate into the interior of the unidirectional web, which makes possible the homogenization of the dry web and can facilitate the manufacture of unidirectional webs having a high basis weight.

Application EP 2 794 221 proposes to treat a unidirectional web with a liquid polymeric binder composition that penetrates into the web, said binder composition representing no more than 15% of the final weight of the reinforcing material obtained. Nevertheless, the use of this method results in low permeabilities (in particular transverse permeabilities), due to the extreme compaction of the reinforcing filaments, thus resulting in decreased permeability.

Further, the transverse electrical conductivity of the parts obtained with such materials wherein the reinforcing fibers are carbon fibers, is substantially lower than that obtained with the technique using micro-perforations.

In addition, application WO 2008/155504 in the name of the applicant describes a method for the manufacture of a composite material wherein at least one twisted yarn is applied to a laying surface, and along a trajectory having at least one curved zone on the laying surface and wherein the reinforcing yarn is bonded to the laying surface by means of a polymeric binder. The method is used to produce complex-shaped parts or preforms when the lay-up of a yarn on a curved zone is necessary and proposes to apply to the yarn upstream of its lay-up a twist chosen to at least compensate for the differences in length presented by the extreme paths of the yarn on either side of its width measured parallel to the laying surface.

WO 2013/133437 describes a very specific material consisting of carbon yarns comprising 50,000 to 60,000 filaments that are twisted having a twist from 5 turns/m to 50 turns/m and arranged in the same direction, so as not to overlap, to provide a carbon sheet with a basis weight greater than 800 g/m2 and less than or equal to 6,000 g/m2, suitable for an RTM process. The proposed materials are intended to be used in wind turbine blades, vehicles, or boats, but are not suitable for the field of aeronautics.

The object of the present invention is therefore to provide new reinforcing materials, for the production of composite parts in association with an injected or infused resin, which comprise at least one unidirectional reinforcing web of a plurality of carbon yarns, and which are suitable for the field of aeronautics. These reinforcing materials, which, while retaining high transverse permeability, exhibit improved lay-up performance, reduced overrun after lay-up, and improved transverse electrical conductivity. They can also be produced at high grammages, without altering their lay-up performance, which remains satisfactory and results in reduced overrun after lay-up.

Further, the invention proposes to provide reinforcing materials that have high transverse permeability and allow satisfactory diffusion of the resin to be later injected or infused therein during the subsequent production of composite parts.

Another object of the invention is to provide new reinforcing materials for the production of composite parts in association with an injected or infused resin, having satisfactory transverse electrical conductivity, in particular for applications in the field of aeronautics.

Another object of the invention is to provide new materials for which the manufacturing method is easily automated, while producing reinforcing materials having satisfactory and controlled quality. The materials according to the invention can therefore be produced in long lengths and at a high rate.

### DISCLOSURE OF THE INVENTION

In this context, the present invention relates to a reinforcing material comprising a unidirectional reinforcing web formed of a series of at least 3 twisted carbon reinforcing yarns, associated on one of its faces or each of its faces with a porous polymeric fiber layer, the polymeric portion of the reinforcing material representing from 0.5% to 10% of its total weight, and preferably from 2% to 6% of its total weight.

Said carbon reinforcing yarns are individually twisted having a twist from 3 turns/m to 15 turns/m, preferably 6 turns/m to 12 turns/m, and comprise at least one twisted carbon reinforcing S-twist yarn and at least one twisted carbon reinforcing Z-twist yarn, with:
when the total number of twisted carbon reinforcing yarns forming the unidirectional reinforcing web (referred to as total number of yarns) is even, the number of twisted carbon reinforcing S-twist yarns on one side of the plane Δ and the number of twisted carbon reinforcing S-twist yarns on the other side of the plane Δ are each independently an integer within the range {[(total number of yarns)/4]−35%; [(total number of yarns)/4]+35%}, each endpoint of the range being rounded to the nearest integer if the formula defining it results in an integer, the other twisted carbon reinforcing yarns being Z-twist yarns (definition P1);
when the total number of twisted carbon reinforcing yarns forming the unidirectional reinforcing yarn (referred to as total number of yarns) is odd, the number of twisted carbon reinforcing S-twist yarns on one side of the plane Δ and the number of twisted carbon reinforcing S-twist yarns on the other side of the plane Δ are either two integers or two and a half integers, and are each, independently, within the range {[(total number of yarns)/4]−35%; [(total number of yarns)/4]+35%}, each endpoint of the range being rounded to the nearest integer or integer and a half if the formula defining it results in an integer or integer and a half, the other twisted carbon reinforcing yarns being Z-twist yarns (definition I1);
the plane Δ being the plane parallel to the general direction of extension of said unidirectional web and which divides said unidirectional web into two equal parts, being perpendicular to its surface. In other words, the number of twisted carbon reinforcing yarns forming the unidirectional reinforcing web (within the scope of the invention referred to as the “total number of yarns” in the definition of the ranges for the sake of simplicity) is equal on both sides of the plane Δ, which is located at the level of the neutral fiber of the unidirectional reinforcing web. Therefore, if a unidirectional reinforcing web consists of n (n being an integer greater than 3) twisted carbon reinforcing yarns, then there are n/2 twisted carbon reinforcing yarns on either side of the plane Δ.

Further, a unidirectional reinforcing web comprising an integer m of twisted carbon reinforcing S-twist yarns, the sum of the number m1 of twisted carbon reinforcing S-twist yarns lying on one side of the plane Δ and the number m2 of twisted carbon reinforcing S-twist yarns lying on the other side of the plane Δ is an integer. Similarly, a unidirectional reinforcing web comprising an integer p of twisted carbon reinforcing Z-twist yarns, the sum of the number p1 of twisted carbon reinforcing Z-twist yarns lying on one side of the plane Δ and the number p2 of twisted carbon reinforcing Z-twist yarns Z lying on the other side of the plane Δ is an integer. Thus, for example, in the case of a unidirectional reinforcing web formed of a sequence of twisted carbon reinforcing SZSZSZS yarns (twist of the yarns laid contiguously) satisfying definition I1, the number of yarns n/2 on either side of the plane Δ is 3.5, m1=m2=2 and p1=p2=1.5.

According to one advantageous feature, said unidirectional reinforcing web is formed of a series of S-twist twisted carbon reinforcing yarns and a series of Z-twist twisted carbon reinforcing yarns having one of the configurations (SZ)i, S(ZS)j, or Z(SZ)j, with i and j being integers in particular within the range from 2 to 20, preferably within the range from 2 to 10.

According to certain embodiments, the unidirectional reinforcing web has a grammage within the range from 126 g/m² to 1000 g/m², in particular from 126 g/m² to 420 g/m², preferably from 126 g/m² to 280 g/m², and most preferably from 126 g/m² to 210 g/m², or 210 g/m² to 280 g/m².

In particular, the unidirectional reinforcing web is formed of twisted carbon reinforcing yarns having a titer from 3 K to 24 K, preferably from 6 K to 12 K.

According to one embodiment, the porous polymeric layer or layers present is (are) a porous film, a scrim, a powder coating, a liquid polymer coating, a woven fabric or, preferably, a non-woven material or veil.

Within the scope of the invention, the porous polymeric layer or layers advantageously has (have) a thermoplastic nature and, in particular, consist(s) of a thermoplastic polymer, a partially crosslinked thermoplastic polymer, a mixture of such polymers, or a mixture of thermoplastic and thermosetting polymers.

The polymeric fiber layer or layers present has (have) a hot-melt quality and its (their) association with the unidirectional reinforcing web is achieved by means of this hot-melt quality.

Advantageously, the porous polymeric layer or layers are non-woven materials, and in the case where each of the faces of the unidirectional reinforcing web is associated with a porous polymeric layer, these porous polymeric layers are preferably identical non-woven materials.

Typically, said non-woven material or materials has (have) a basis weight within the range from 0.2 g/m² to 20 g/m 2 and/or a thickness from 0.5 microns to 50 microns, preferably from 3 microns to 35 microns.

The reinforcing material according to the invention has, advantageously, the feature of not being perforated, sewn, knitted, or woven.

Within the scope of the invention, the use of carbon reinforcing yarns that have previously undergone a twisting operation, so as to have within the reinforcing material according to the invention, a series of carbon yarns having a twist from 3 t/m to 15 t/m, makes it possible:
to obtain a bond between the upper and lower faces of the unidirectional web, increasing transverse cohesion and thus making it possible to integrate high grammage webs, while retaining satisfactory performance for the reinforcing material obtained, compatible with its handling and its lay-up;
to create between the two faces of the unidirectional web, by means of the twisted reinforcing yarns, continuity of diffusion for the resin that will be injected or infused during production of the composite part. The continuity of the filaments of the twisted reinforcing yarns that join the two faces of the unidirectional web contributes to transverse permeability. In addition, the twisted carbon yarns are able to create channels extending along the filaments of the twisted carbon yarns that join the two faces of the unidirectional web. Thus, transverse permeability is obtained by means of a multitude of permeabilities extending at the level of the twisted carbon yarns, following the filaments which extend from one face to the other of the unidirectional web;
to create by means of the carbon yarns which are electrical conductors, continuity of the electrical conductivity along the filaments of the twisted yarns that join the two faces of the unidirectional web.

By using a unidirectional web formed of more than three twisted carbon reinforcing yarns, wherein there is a balance between the number of twisted carbon reinforcing S-twist yarn(s) and the number of twisted carbon reinforcing Z-twist yarn(s), in accordance with definitions P1 and I1, it is possible to obtain reinforcing materials that have fewer defects, even when these reinforcing materials are made using automated processes on an industrial scale. The lay-up of the reinforcing materials according to the invention is also better controlled, as their trajectory can be more easily maintained parallel to the general direction of extension of the unidirectional web.

The invention is of even more particular relevance for reinforcing materials having a width greater than 7 mm, preferably greater than 12 mm, and preferably within the range from 12 mm to 51 mm, and preferably having a length from 2 m to 5000 m, preferably from 100 m to 2000 m.

The invention relates to reinforcing materials for the production of composite parts, by means of a direct process. That is, in order to produce composite parts, the reinforcing materials according to the invention should be associated with a polymeric resin that will be injected or infused within said reinforcing material or a stack of such reinforcing materials. Also, conventionally, the weight of the polymeric portion of the reinforcing material according to the invention represents not more than 10% of the total weight of the reinforcing material according to the invention. Typically, the polymeric portion of the reinforcing material represents from 0.5% to 10% of the total weight of the reinforcing material, and preferably from 2% to 6% of its total weight. This polymeric portion corresponds to the total portion of polymer(s) present within the reinforcing material according to the invention: it therefore includes the porous polymeric layer or layers present within the reinforcing material according to the invention or consists of the porous polymeric layer or layers present within the reinforcing material according to the invention. The advantages of the invention are obtained without the need to increase the polymeric portion of the material, that is, the amount of polymeric material present, in the porous polymeric layer or layers present on one side of the unidirectional web, and advantageously on both sides of the unidirectional web, that is, on each of its faces.

With the exception of the use of twisted carbon yarns according to the proposal of the invention to make the unidirectional web and even high grammage unidirectional webs, the polymeric porous layers of the materials according to the invention correspond to those described in the prior art, and in particular in application WO 2010/046609, prior to the micro-perforation step.

The unidirectional reinforcing web consists of an assembly ///// of carbon reinforcing yarns, all of which are twisted and located contiguously. After the unidirectional web is formed, it can be associated, in particular by lamination, on one of its faces, and preferably on each of its faces, with a porous polymeric layer.

According to another feature, the invention relates to a method for the preparation of a reinforcing material comprising the following successive steps:
a1) providing a unidirectional reinforcing web formed of a series of at least 3 individually twisted carbon yarns having a twist from 3 to 15 turns/m, preferably from 6 turns/m to 12 turns/m and comprising at least one twisted carbon reinforcing S-twist yarn and at least one twisted carbon reinforcing Z-twist yarn, and, with:
when the total number of twisted carbon reinforcing yarns forming the unidirectional reinforcing web is even, the number of twisted carbon reinforcing S-twist yarns on one side of the plane Δ and the number of twisted carbon reinforcing S-twist yarns on the other side of the plane Δ which are each independently an integer within the range {[(total number of yarns)/4]−35%; [(total number of yarns)/4]+35%}, each endpoint of the range being rounded to the nearest integer if the formula defining it does not result in an integer, the other twisted carbon reinforcing yarns being Z-twist yarns;
when the total number of twisted carbon reinforcing yarns forming the unidirectional reinforcing web is odd, the number of twisted carbon reinforcing S-twist yarns on one side of the plane Δ and the number of twisted carbon reinforcing S-twist yarns on the other side of the plane Δ, which are either two integers or two and a half integers, and are each independently within the range {[(total number of yarns)/4]−35%; [(total number of yarns)/4]+35%}, each endpoint of the range being rounded to the nearest integer or integer and a half if the formula defining it does not result in an integer or integer and a half, the other twisted carbon reinforcing yarns being Z-twist yarns]; the plane Δ being the plane parallel to the general direction of said unidirectional web and which divides said unidirectional web into two equal parts, being perpendicular to its surface;
a2) providing one or two porous polymeric layers;
a3) associating said porous polymeric layer with one of the faces of the unidirectional reinforcing web and, in the case of two porous polymeric layers, associating each of them with each of the faces of the unidirectional reinforcing web.

For example, the preparation method comprises, upstream of step a1), a step for the production of the unidirectional reinforcing web comprising the application of a twist from 3 turns/m to 15 turns/m to one or a series of carbon reinforcing yarns having an S-twist, said twist being applied individually to each carbon reinforcing yarn, and applying a twist from 3 turns/m to 15 turns/m to one or a series of carbon reinforcing yarns having a Z-twist, said twist being applied individually to each carbon reinforcing yarn.

According to one embodiment, the preparation method comprises, upstream of step a1):
i) applying a twist from 3 turns/m to 15 turns/m to one or a series of carbon reinforcing yarns having an S-twist, said twist being applied individually to each carbon reinforcing yarn and applying a twist from 3 to 15 turns/m to one or a series of carbon reinforcing yarns having a Z-twist, said twist being applied individually to each carbon reinforcing yarn,
ii) aligning the twisted reinforcing yarns thus obtained, and arranging said yarns contiguously, so as to form a unidirectional reinforcing web comprising at least one S-twist yarn and at least one Z-twist yarn, and, with:
when the total number of twisted carbon reinforcing yarns forming the unidirectional reinforcing web is even, the number of twisted carbon reinforcing S-twist yarns on one side of the plane Δ and the number of twisted carbon reinforcing S-twist yarns on the other side of the plane Δ which are each independently an integer within the range {[(total number of yarns)/4]−35%; [(total number of yarns)/4]+35%}, each endpoint of the range being rounded to the nearest integer if the formula defining it does not result in an integer, the other twisted carbon reinforcing yarns being Z-twist yarns;
when the total number of twisted carbon reinforcing yarns forming the unidirectional reinforcing web is odd, the number of twisted carbon reinforcing S-twist yarns on one side of the plane Δ and the number of twisted carbon reinforcing S-twist yarns on the other side of the plane Δ, which are either two integers or two and a half integers, and are each independently within the range {[(total number of yarns)/4]−35%; [(total number of yarns)/4]+35%}, each endpoint of the range being rounded to the nearest integer or integer and a half if the formula defining it does not result in an integer or integer and a half, the other twisted carbon reinforcing yarns being Z-twist yarns;

the plane Δ being the plane parallel to the general direction of said unidirectional web and which divides said unidirectional web into two equal parts, being perpendicular to its surface.

In such a method, the porous polymeric layer or layers has (have) a hot-melt quality and the association of step a3) is advantageously obtained by applying one or more of the porous polymeric layers to one of the faces or each of the faces of the unidirectional reinforcing web, respectively, said lay-up being accompanied or followed by heating the polymeric fibers, causing their softening or melting, which is then followed by cooling.

Another object of the invention is a preform consisting, at least in part, of one or a plurality of reinforcing materials according to the invention.

Another object of the invention relates to a method for the manufacture of a composite part from at least one reinforcing material according to the invention. According to this manufacturing method, a thermosetting resin, a thermoplastic resin, or a mixture of thermosetting and thermoplastic resins is injected or infused within said reinforcing material, a stack of a plurality of reinforcing materials according to the invention, or a preform according to the invention.

In particular, such a method comprises, prior to the infusion or injection of the resin, a step of forming a ply or a stack comprising a plurality of reinforcing materials according to the invention, during which said reinforcing material is conveyed and circulates, continuously, within a guiding member, in order to ensure its positioning, during its lay-up leading to the desired ply or stack. Conventionally, the material according to the invention is cut to the desired size, in particular to the desired length, for forming the ply or stack to be produced.

Advantageously, this method for the manufacture of a composite part comprises, prior to the infusion or injection of the resin, a lay-up or shaping, which preferably utilizes the hot-melt quality of the porous polymeric layers present in the reinforcing material or materials.

Another object of the invention relates to the use of one or a plurality of reinforcing material(s) according to the invention, for the production of a preform, or a composite part in association with a thermosetting resin, a thermoplastic resin or a mixture of thermosetting and thermoplastic resins.

Advantageously, a thermosetting resin, and in particular an epoxy resin, is injected or infused.

The invention will be better understood from the following detailed description, with reference to the attached figures.

### BRIEF DESCRIPTION OF THE DRAWINGS

FIG. 1A is a partial schematic view of a reinforcing material according to the invention, in cross-section parallel to the general direction of extension of the unidirectional web 2.

FIG. 1B is a schematic perspective view, partially cut away, showing a reinforcing material not conforming to the invention, wherein unidirectional web 2′ is formed of a series of twisted yarns having the same twist.

FIG. 1C is a schematic, partially cut away perspective view showing a reinforcing material according to the invention wherein the unidirectional web is formed of a series of twisted reinforcing yarns 3, in an SZSZSZ configuration, reading the figure from right to left, that is, an S-twist yarn is laid next to a Z-twist yarn, which is in turn laid next to a S-twist yarn, and so forth.

FIG. 2 is a schematic view showing the twist on a twisted carbon yarn according to the invention.

FIG. 3 is a schematic view illustrating the principle of a twisting machine for applying a twist to carbon yarns.

FIG. 4 is a schematic view of a measuring station suitable for measuring the width of carbon yarns, especially twisted carbon yarns.

FIG. 5 e is a graph showing the average width of carbon yarns (mm) as a function of the twist (tpm), for various carbon yarns.

FIG. 6 is a graph showing the standard deviation of the average widths (mm) of carbon yarns as a function of twist, for various carbon yarns.

FIG. 7 is a graph showing, for a grammage of 140 g/m2, the percentages of values above the target value for the width of carbon yarns, as a function of twist, for various carbon yarns.

FIG. 8 is a graph showing, for a grammage of 210 g/m2, the percentages of values above the target value for the width of carbon yarns, as a function of twist, for various carbon yarns.

FIG. 9 is a graph showing, for a grammage of 280 g/m2, the percentages of values above the target value for the width of carbon yarns, as a function of twist, for various carbon yarns.

FIG. 10 is a graph showing, for a grammage of 252 g/m2, the percentages of values above the target value for the width of carbon yarns, as a function of twist, for various carbon yarns.

FIG. 11 is a graph showing, for a grammage of 350 g/m2, the percentages of values above the target value for the width of the reinforcing yarns, as a function of twist, for various reinforcing yarns.

FIG. 12 is a schematic diagram showing the position of the measuring points on a preform.

FIG. 13 is a schematic diagram illustrating the principle of measuring the thickness of a carbon yarn preform.

FIG. 14 is a graph showing the change in the overrun as a function of the number of plies applied, for material 2 consisting of a unidirectional carbon yarn web, of 280 g/m² basis weight, made of 4 yarns twisted at 10 turns/m having an S-twist, and the micro-perforated comparative material 1.

FIG. 15 is a graph of the transverse permeability (m²) as a function of fiber volume ratio (FVR) of a micro-perforated comparative material or materials consisting of a unidirectional carbon yarn web all being twisted with an S twist.

FIG. 16 shows the differences observed in forming a ply made of reinforcing materials 6.35 mm wide consisting of a unidirectional carbon yarn web, with a 280 g/m² basis weight, made of 4 yarns twisted at 10 turns/m, having 3 different configurations: SSSS, SZZS and SZSZ. A partial schematic view of the top of the unidirectional layers presents in each case within the reinforcing materials used is shown on the right, with a depiction above each partial schematic view of the S- or Z twisting direction of the reinforcing yarns of each unidirectional layer, along the cross-section of said yarns.

FIG. 17 shows the gap obtained at the junction between the 7 reinforcing yarns having an S-type twist and the 5 reinforcing yarns having a Z-type twist, during the production of a unidirectional carbon yarn web, with a basis weight of 210 g/m2 and a width of 38.1 mm, produced with a SSSSSSSZZZZZZSSSSSS configuration (7 S-type twist yarns, then 5 Z-twist yarns, then 6 S-twist yarns). Indeed, during the production of the unidirectional web, the groups of S-twist yarns are driven to the left, while the group of Z-twist yarns is driven to the right, which creates a gap at the junction of 7 S-twist yarns/5 Z-twist yarns.

FIG. 18 is a schematic representation of a production line used in the examples.

### DESCRIPTION OF THE EMBODIMENTS

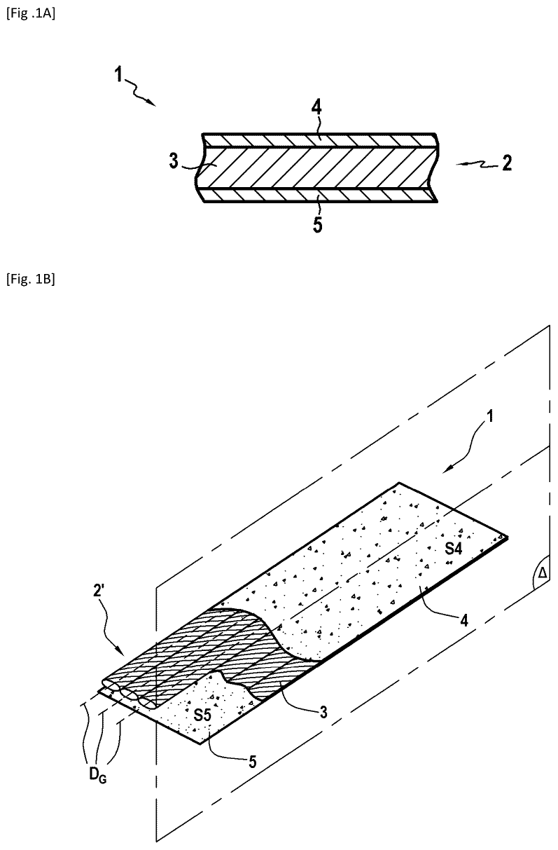

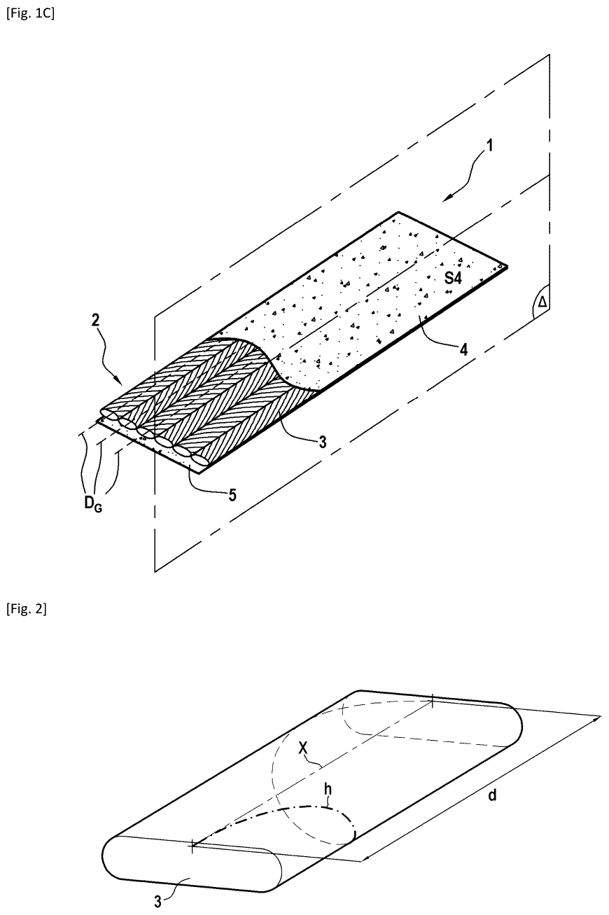

One object of the invention relates, as shown in FIG. 1A, to a reinforcing material 1 comprising a unidirectional reinforcing web 2 formed of more than three carbon reinforcing yarns 3, associated on at least one of its faces and advantageously on each of its faces, with a porous polymeric layer 4, 5. According to the invention, an embodiment whereof is shown in FIG. 1C, the reinforcing material 1 according to the invention consists of a unidirectional reinforcing web 2 formed of more than three carbon reinforcing yarns 3, associated on one of its faces and advantageously on each of its faces, with a porous polymeric layer 4, 5.

More precisely, as will be described in detail in the description below, the carbon reinforcing yarns 3 forming the unidirectional reinforcing web 2 are all individually twisted.

FIG. 1C shows a unidirectional web 2 made of a plurality of individually twisted carbon reinforcing yarns 3, associated on each of its faces with a veil 4, 5. Each twisted reinforcing yarn 3 has a general direction of extension DG (which corresponds to the central axis of the yarn) which is rectilinear in the plane of extension of the unidirectional web. Each twisted reinforcing yarn 3 has a general direction of extension DG that extends rectilinearly, parallel to the extension surfaces S4 and S5 of the veils 4, 5, which in FIG. 1B are planes. In the web 2′ shown in FIG. 1B, all the yarns are twisted having an S-twist, which does not correspond to a concatenation (also referred to as configuration) of yarns according to the invention.

“Unidirectional reinforcing web” means a web made up exclusively or almost exclusively of carbon yarns arranged parallel to each other. “Arranged in parallel” means that the general directions of extension DG of the reinforcing yarns are all parallel to one another or substantially parallel to one another. It is generally accepted by a person skilled in the art that a deflection between certain general directions of extension DG of two reinforcing yarns of less than or equal to 3°, preferably less than or equal to 2°, and more preferably less than or equal to 1°, does not modify the unidirectional nature of the web. The general direction of extension of the unidirectional web corresponds to the general direction of extension DG of the reinforcing yarns if these are all parallel to each other or to the mean of these general directions of extension, for the rare cases where there is not a strict parallelism between all the directions of extension DG of the reinforcing yarns 3 forming the unidirectional web 2.

In a unidirectional web, the reinforcing yarns are arranged contiguously to ensure optimal coverage of the surface. In particular, it is desirable to avoid local gaps greater than 1 mm, perpendicular to the direction of extension of the unidirectional web, over a length greater than 10 cm (that is, parallel to the direction of extension of the unidirectional web).

Thermoplastic-type binder yarn, in particular, of polyamides, copolyamides, polyesters, copolyesters, copolyamides-block ester/ether, polyacetals, polyolefins, thermoplastic polyurethanes, or phenoxy, can be used to facilitate the handling, if necessary, of the unidirectional reinforcing web 2, before its association with the porous polymeric layer or layers. This binder yarn usually extends transversely to the carbon yarns. The term “unidirectional web” also includes unidirectional woven fabrics, wherein spaced weft yarns interweave with carbon yarns that run parallel to each other and are the warp yarns of the unidirectional fabric. Even in these different cases, where such binding, stitching, or weft yarns are present, the carbon yarns parallel to each other account for at least 95% by weight of the web, which is therefore described as “unidirectional”. Nevertheless, according to a particular embodiment of the invention, the unidirectional web does not comprise any weft yarns interweaving the carbon yarns, so as to avoid any corrugation. In particular, the reinforcing material according to the invention does not comprise any perforations, weaving, sewing, or knitting. In the unidirectional web, the carbon yarns are preferably not associated with a polymeric binder and are therefore described as dry, that is, they are neither impregnated, nor coated, nor associated with any polymeric binder before their association with the porous polymeric layers 4, 5. The carbon yarns are, however, usually characterized by a standard sizing basis weight of up to 2% of their weight.

A carbon reinforcing yarn (which can be referred to more simply as reinforcing yarn or carbon yarn within the scope of the invention) is generally made of an assembly of fibers or filaments and generally comprises from 1,000 to 320,000 filaments, advantageously from 12,000 to 24,000 filaments. In a particularly preferred embodiment, within the scope of the invention, carbon yarns of 1 K to 24 K are used. The constituent fibers are preferably continuous. The carbon yarns used generally have a substantially circular cross-section (classified as round yarns) or, preferably, a substantially parallelepipedal or elliptical cross-section (classified as flat yarns). These yarns have a certain width and thickness. As an example of loose yarns having no contact with any physical element, a flat carbon yarn of 3K and a titer of 200 tex generally has a width from 1 mm to 3 mm, a flat carbon yarn of 12K and a titer of 446 tex has a width from 2 mm to 5 mm, a 12K carbon flat yarn of 800 tex titer has a width from 3 mm to 7 mm, a 24K carbon flat yarn of 1600 tex titer has a width from 5 mm to 12 mm and a 24K carbon flat yarn of 1040 tex titer has a width from 5 mm to 10 mm. A flat carbon yarn of 3,000 to 24,000 filaments will therefore usually have a width from 1 mm to 12 mm. Among carbon yarns, there are High Resistance (HR) yarns having a tensile modulus from 220 GPa to 241 GPa and a tensile strength from 3450 MPa to 4830 MPa, Intermediate Modulus (IM) yarns having a tensile modulus from 290 GPa to 297 GPa and a tensile strength from 3450 MPa to 6200 MPa and High Modulus (HM) yarns having a tensile modulus from 345 GPa to 448 GPa and a tensile strength from 3450 Pa to 5520 Pa (according to the “ASM Handbook”, ISBN 0-87170-703-9, ASM International 2001). In particular, within the scope of the invention, the unidirectional reinforcing web 2 can be formed of one or a plurality of carbon reinforcing yarns 3 having a titer from 3 K to 24 K, preferably 6 K to 12 K.

Within the scope of the invention, the reinforcing yarns of the unidirectional reinforcing web 2 are made of a series of individually twisted carbon yarns 3 having a twist from 3 turns/m to 15 turns/m, preferably 6 turns/m to 12 turns/m, said series of yarns comprising at least 3 yarns thus individually twisted. According to the invention, a twisted carbon yarn 3 is a carbon yarn to which a twist has been applied, that is, a relative rotation of the outer edges of the yarn, about its neutral fiber (corresponding to the central axis of the yarn), so that these describe a helical trajectory, that is, the tangent at each point makes a substantially constant angle with a given direction. As shown in FIG. 2, a twisted carbon yarn 3 has, at its core, a neutral fiber with a general direction corresponding to the longitudinal direction X (also referred to as the general direction of extension DG) of the carbon yarn 3, while the filaments follow a helical path around this general direction. FIG. 2 schematically shows the helical shape of a generatrix h of a twisted carbon yarn 3 having a twist from one turn over a linear distance d taken along the longitudinal direction X (also referred to as the general direction of extension DG).

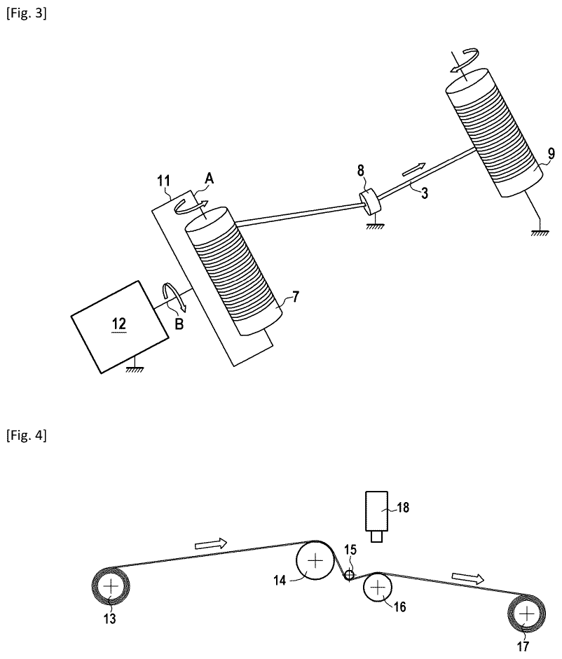

Each carbon yarn 3 is individually twisted. Such a twist can be obtained, for example, by using a twisting machine such as a machine marketed by Kamitsu Seisakusho Ltd., model UT-1000. FIG. 3 is a diagram illustrating the twisting process performed by a twisting machine and making it possible to obtain a twisted carbon yarn 3 according to the invention. A spool 7 on which a carbon yarn to be twisted is wound is mounted so that it can rotate about its axis A to allow the carbon yarn to be unwound, by means of a yarn guide 8, to a spool 9 for winding the twisted carbon yarn 3. The spool 7 provided with the carbon yarn to be twisted is mounted on a support 11 driven in rotation by a motor 12 along an axis B perpendicular to the axis of the spool 7. The twist from the carbon yarn 3 depends on the linear speed of unwinding of the carbon yarn and the speed of rotation of the support 11 of the spool 7.

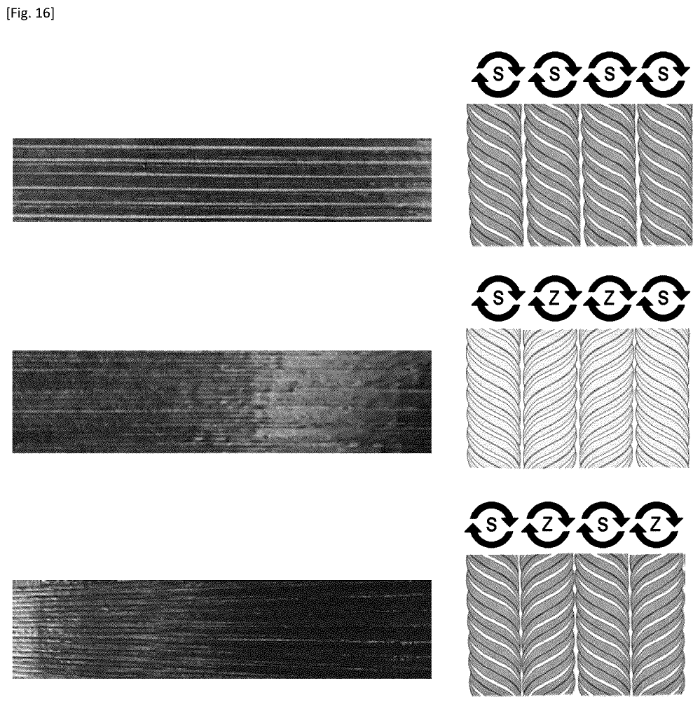

According to another embodiment of the object of the invention, the unidirectional reinforcing web 2 is formed of at least one twisted carbon S-type twist yarn 3 and at least one twisted carbon Z-type twist yarn. The S-type and Z-type twisted carbon reinforcing yarns 3 differ in their twist direction, as shown in FIG. 16. For definitions of what is meant by S-twist or Z-type twist, refer to the book “Handbook of Weaving”, p 16-17 by Sabit Adanur, Professor, Department of Textile Engineering, Auburn, USA, ISBN 1-58716-013-7.

As indicated, the unidirectional reinforcing web 2 is formed of a plurality of carbon yarns 3, of which there are at least 4, each having a twist from 3 turns/m to 15 turns/m, preferably 6 turns/m to 12 turns/m. Each yarn has an direction of extension DG which corresponds to the central axis of the yarn. The twisted reinforcing yarns 3 forming the unidirectional reinforcing web 2 are arranged contiguously and the directions of extension of the twisted reinforcing yarns 3 are parallel to each other, thus forming a unidirectional web. It should be understood that all the carbon yarns 3 forming the unidirectional reinforcing web 2 are individually twisted having a twist from 3 turns/m to 15 turns/m, preferably 6 turns/m to 12 turns/m.

According to the invention, both one or a plurality of twisted reinforcing S-twist yarns 3 and one or a plurality of twisted reinforcing Z-twist yarns 3 can be used within the same web. That is, the unidirectional web 2 comprises twisted reinforcing yarns 3 having different twist directions: it is therefore not formed solely of reinforcing Z-twist yarns 3 or reinforcing S-twist yarns 3, but comprises at least one reinforcing Z-twist yarn 3, extending next to one or a plurality of reinforcing S-twist yarns 3, or comprises at least one reinforcing S-twist yarn 3, extending next to one or more reinforcing Z-twist yarns 3. In contrast, each yarn has the same S-twist or the same Z-twist and thus the same direction of twist over its entire length, as well as the same twist value. Such unidirectional reinforcing webs 2 are referred to in this description as “mixed S/Z unidirectional webs 2” for the sake of simplicity. Obtaining a twisted reinforcing yarn 3 with an S-twist or a twisted reinforcing yarn 3 with a Z-twist is affected by the direction of rotation applied about the B-axis to the spool 7, in a twisting machine as shown in FIG. 3. By using various types of twisted reinforcing yarns 3 within the same unidirectional reinforcing web 2, namely at least one with an S-twist and at least one with a Z-twist, as defined within the scope of the invention, it is possible to limit the likelihood of defects appearing within the unidirectional reinforcing web 2 obtained, in particular the risks of gaps or overlaps between the yarns laid contiguously, as well as the risks of corrugation. The use of the two types of twist (S-twist and Z-twist) proposed in the scope of the invention, within the same unidirectional web, tends to even out the local corrugations induced by the Z-twists and S-twists, which have different directions. By combining these two types of yarns in the same unidirectional web, the manufacture and use of mixed S-twist and Z-twist yarns is simplified and tends to yield a more acceptable quality in terms of the gap and overlap observed in the web produced, as will be shown in the following examples.

As shown in FIG. 1C, a unidirectional web 2 formed of a plurality of carbon reinforcing yarns 3 can be divided into two equal parts each extending on either side of a plane Δ extending perpendicular to the surface of said unidirectional web 2 (and thus extending perpendicular to the surfaces S4 and S5 of the two veils 4,5, when the web is associated with these two veils) and parallel to the direction of extension of the unidirectional web 2.

In the reinforcing materials according to the invention, the unidirectional webs 2 (of the mixed S/Z type) comprise more than 3 carbon reinforcing yarns 3 individually twisted having a twist from 3 turns/m to 15 turns/m, preferably 6 turns/m to 12 turns/m, with:
in the case where the total number of twisted carbon reinforcing yarns 3 forming the unidirectional web 2 is even:
the number of twisted carbon reinforcing S-twist yarns 3 on one side of the plane Δ and the number of twisted carbon reinforcing S-twist yarns 3 on the other side of the planeΔ which are, each independently, an integer within the range {[(total number of yarns)/4]−35%; [(total number of yarns)/4]+35%}, each endpoint of the range being rounded to the nearest integer if the formula defining it does not result in an integer, the other twisted reinforcing yarns 3 being Z-twist yarns (definition P1);
which is equivalent to saying that the number of twisted reinforcing Z-twist yarns 3 on one side of the plane Δ and the number of twisted reinforcing Z-twist yarns 3 on the other side of the planeΔ, are, each independently, an integer within the range {[(total number of yarns)/4]−35%; [(total number of yarns)/4]+35%}, each endpoint of the range being rounded to the nearest integer if the formula defining it does not result in an integer, the other twisted reinforcing yarns 3 being S-twist yarns (definition P2);
in the case where the total number of twisted carbon reinforcing yarns 3 forming the unidirectional web 2 is odd:
the number of twisted reinforcing S-twist yarns 3 on one side of the plane Δ and the number of twisted reinforcing S-twist yarns 3 on the other side of the plane Δ, which are either two integers or two and a half integers, and are, each independently, within the range {[(total number of yarns)/4]−35%; [(total number of yarns)/4]+35%}, each endpoint of the range being rounded to the nearest integer or integer and a half if the formula defining it does not result in an integer or integer and a half, the other twisted reinforcing yarns 3 being Z-twist yarns (definition I1);
which is equivalent to saying that the number of twisted reinforcing Z-twist yarns 3 on one side of the plane Δ and the number of twisted reinforcing Z-twist yarns 3 on the other side of the plane Δ, are either two integers or two and a half integers, and are, each independently, within the range {[(total number of yarns)/4]−35%; [(total number of yarns)/4]+35%}, each endpoint of the range being rounded to the nearest integer or integer and a half if the formula defining it does not result in an integer or integer and a half, the other twisted reinforcing yarns 3 being S-twist yarns (definition I2).

The plane Δ is the plane parallel to the general direction of extension of said unidirectional web 2 which divides said unidirectional web into two equal parts, being perpendicular to its surface. FIG. 1C shows a material according to the invention comprising a unidirectional web 2 formed of a series of twisted reinforcing SZSZSZ yarns 3, on which the plane Δ is shown.

“Are, each independently, in the range” in the definitions P1, P2, I1 and I2 means that the two numbers concerned are within the range but may be either identical or different.

As an example of possible configurations in the case of an odd total number of twisted reinforcing yarns 3 forming a unidirectional web 2, if this total number of twisted reinforcing yarns 3 is 17 (there are thus 8.5 yarns on both sides of the plane Δ), then:
according to definition I1, the range {[(total number of yarns)/4]−35%; [(total number of yarns)/4]+35%} is equal to {[(17/4]−35%; [(17)/4]+35%}={4.25−35% (4.25); 4.25+35% (4.25)}, which after rounding off the endpoints yields {3; 5.5}. Thus, there can be from 3 to 5.5 S-twist yarns on each side of the plane Δ, that is, from 6 to 11 S-twist yarns in total, the other yarns being Z-twist yarns, that is, 6 to 11 Z-twist yarns in total, with 3 to 5.5 Z-twist yarns on each side of the plane Δ;
according to definition I2, we arrive at the same number of possible S-twist and Z-twist yarns on each side of the plane Δ.

Other examples of sequences of twisted reinforcing yarns 3 laid contiguously to form a mixed S/Z unidirectional web 2, which are particularly suitable, include the following sequences: SZZS, SZSZ, SZSZS, SSZZSS, SZSSZS, SZSZSZ SSZZSSZZ.

For such configurations, the number of twisted reinforcing S-twist yarns and the number of twisted reinforcing Z-twist yarns 3 within the unidirectional reinforcing web 2 are more balanced, resulting in unidirectional webs 2 being easier to manufacture and of higher quality. Indeed, in such cases, the alignment between the twisted reinforcing yarns 3 is facilitated and there is a reduction in gaps, corrugations and/or overlaps between the twisted reinforcing yarns 3 laid parallel and contiguously, during the forming of the unidirectional reinforcing web 2, as explained in the examples. Further, during the automated production of a plurality of reinforcing materials 1, in parallel, as described in application WO 2010/061114, cutting the non-woven materials at the junction between two reinforcing materials 1 produced in parallel in this case results in sharper edges and more homogeneous materials.

Further, the reinforcing material 1 produced from such mixed S/Z unidirectional webs will, as a result, also be of better quality and thus the composite parts produced as well. In addition, lay-up by means of automated lay-up devices, such as those described in EP 2 376 276, can be more precise with such reinforcing materials. As will be explained in the examples, such reinforcing materials 1 remain better centered in the guides or guiding members (of the groove type, or in particular of the comb-type) present at the level of the heads or lay-up fingers of the automated lay-up devices, whereas reinforcing materials 1 made of a unidirectional web of reinforcement 2, comprising only reinforcing S-twist yarns 3 or only reinforcing Z-twist yarns 3, or more generally not meeting the definitions P1, P2, I1 and I2, tend to be off-center and to come into abutment on the edges of the guides or guiding members on which they travel.

In particular, the unidirectional reinforcing webs 2 comprising a sequence of totally alternating S-twist and Z-twist reinforcing yarns 3 is preferred, especially those corresponding to the configurations (that is, the sequence of twisted reinforcing yarns 3 laid contiguously) (SZ)i, S(ZS)j, Z(SZ)j, with i and j being integers in particular within the range from 1 to 20, preferably within the range from 1 to 10. In particular, i and j are within the range from 2 to 20, preferably within the range from 2 to 10.

Other mixed S/Z unidirectional web configurations that are particularly satisfactory are those that have the same number of S-twist yarns, and thus the same number of Z-twist yarns as well, on both sides of the plane Δ. The following configurations are some examples: SZZS, SZSZ, SZSZS, SZSSZS.

Other mixed S/Z unidirectional web configurations that are particularly satisfactory are those that are symmetrical about the plane Δ. Some examples of these configurations are SZZS, SZSZS, SZSSZS, SZSSZSSZS.

Therefore, the use of mixed S/Z unidirectional reinforcing webs 2, and in particular those more precisely described within the scope of the invention, solves a dual technical problem, both during the manufacture and during lay-up of the reinforcing material 1 obtained. These materials offer, in particular, the possibility of being produced and laid using industrial methods.

The use of mixed S/Z unidirectional reinforcing webs 2, and in particular those more precisely described within the scope of the invention, is particularly suitable for the production of unidirectional webs 2, and thus of reinforcing materials 1, having a width from 5 mm to 60 mm. The width is measured perpendicular to the general direction of extension of unidirectional webs 2. In particular, automated lay-up devices exist for applying materials having widths of 6.35 mm; 12.7 mm; 38.1 mm, and 50.8 mm and can be used within the scope of the invention.

Advantageously, each twisted carbon yarn 3 involved in forming the unidirectional reinforcing web 2 has a twist value that is substantially identical over its entire length. Note that all the twisted carbon yarns 3 that form the unidirectional reinforcing web 2 can have either an identical or a different twist value. Preferably, all the twisted carbon yarns 3 that form the unidirectional reinforcing web 2 have an identical twist value, even if their twist direction (S or Z) differs.

It should be understood that twisting results in modification of the width of the twisted carbon yarns.

The following description describes the effect of the twisting process on the widths of the twisted carbon yarn.

FIG. 4 depicts a method for measuring the width of carbon yarns before and after the implementation of the twisting machine operation explained above. The carbon yarn wherein the width is to be measured is unwound from a spool 13 to ensure its passage successively over a first fixed cylindrical bar 14, under a second fixed cylindrical bar 15 and over a third fixed cylindrical bar 16, before being taken up by a take-up spool 17. Typically, the tension of the carbon yarn exiting the spool 13 is from 150 g to 300 g. The cylindrical bars 14-16 are mounted to make it possible to measure the width of the carbon yarn under reproducible and predetermined tension conditions. After being tensioned as it passes over the first fixed cylindrical bar 14 and the second fixed cylindrical bar 15, the carbon yarn expands at the third cylindrical bar 16, above which a matrix camera 18 is positioned. For example, the first, second, and third cylindrical bars 14-16 have diameters of 40 mm, 20 mm, and 30 mm respectively, while the center-to-center distances firstly between the first and second cylindrical bars and secondly between the second and third cylindrical bars are 50 mm and 20 mm in the horizontal direction and 15 mm and 10 mm in the vertical direction, respectively. Measurements of the width of the carbon yarn are made by the camera 18 during the running of the carbon yarn approximately every 5 mm, over a length of 100 linear meters.

The measurements were performed on carbon fibers from HEXCEL Corporation, Stamford, CT, USA, with various linear densities, various numbers of filaments, and various twists, as shown in Table 1 below.

TABLE 1

| | Intermediate | | | | | | | | |
|---|---|---|---|---|---|---|---|---|---|
| | (IM) or High | Linear | | | | | | | |
| | Resistance | density | Number of | | | | | | |
| Fiber | (HR) Modulus | (tex) | filaments | 0 t/m | 3 t/m | 6 t/m | 8 t/m | 10 t/m | 8 t/m |
| IMA | IM | 446 | 12000 | x | x | x | x | x | x |
| IM7 | IM | 223 | 6000 | | x | | x | | x |
| AS7 | HR | 800 | 12000 | x | x | x | x | x | x |

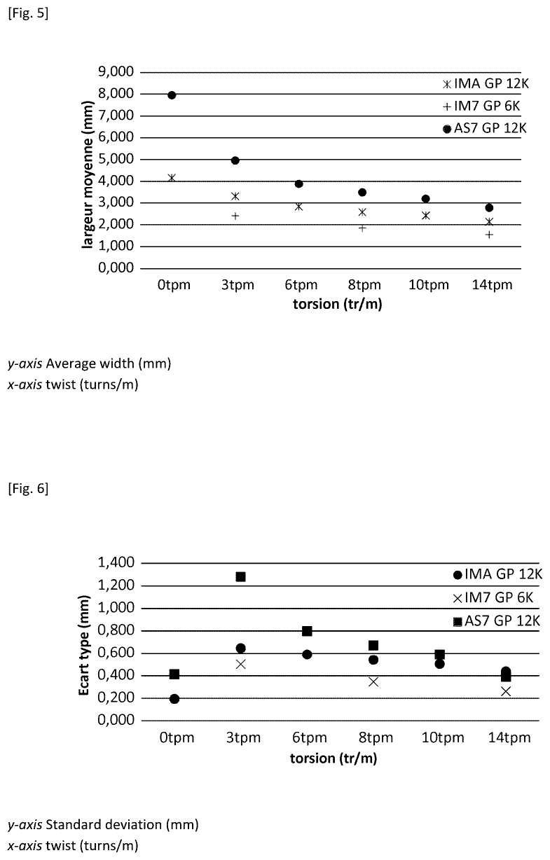

The measurements performed on carbon yarns from Table 1 are shown in FIG. 5, which gives the average width of the carbon yarns as a function of twist, for the various carbon yarns. FIG. 5 clearly shows that the average width of the carbon yarns decreases with increasing twist, which is to be expected, as twisting causes the filaments of the twisted carbon yarns to tighten.

Examination of FIG. 6, which shows the standard deviation of the average widths as a function of twist, for the various carbon yarns in Table 1 reveals that the standard deviations in width decrease with increasing twist. In other words, the twisted carbon yarns tend to tighten more evenly as the twist increases. Thus, with increasing twist, a carbon yarn with a parallelepipedal section tends toward a round reinforcing yarn with a low standard deviation. It should be noted that non-twisted reinforcing yarn has a low standard deviation compared to twisted reinforcing yarn, and that a twist greater than 14 turns per meter (t/m, turns/m, or tpm) should be achieved in order to expect to be able to achieve such low width variability.

It is important to understand that the distribution of the width of carbon yarns will affect the ability to use them for the manufacture of a web with a given basis weight.

For example, a 210 gram per square meter web would require the juxtaposition of 12K IMA yarns every 2.12 mm so that the web would theoretically be completely covered. The calculation is as follows:

Width necessary for a given basis weight [mm]=Titer of the yarn used [Tex]/basis weight [g/m²]. The unit of measurement for yarn is Tex, which is the weight in grams of 1000 m of yarn.

In practice, it is possible to produce a satisfactory quality web if the carbon yarns do indeed statistically have an average width of at least 75% of this so-called “target” width value. A person skilled in the art is usually able to determine this target width value by trial and error.

Table 2 below gives the target width values by basis weight (grammage) and by carbon yarn used:

TABLE 2

| Carbon | Titer | Basis weight | Target value for |
|---|---|---|---|
| yarn | (Tex) | (g/m²) | length (mm) |
| IMA 12K | 446 | 140 | 3.18 |
| | | 210 | 2.12 |
| | | 280 | 1.59 |
| | | 350 | 1.27 |
| IM7 6K | 223 | 140 | 1.59 |
| | | 210 | 1.06 |
| | | 280 | 0.8 |
| | | 350 | 0.64 |
| AS7 12K | 800 | 252 | 3.17 |
| | | 350 | 2.11 |

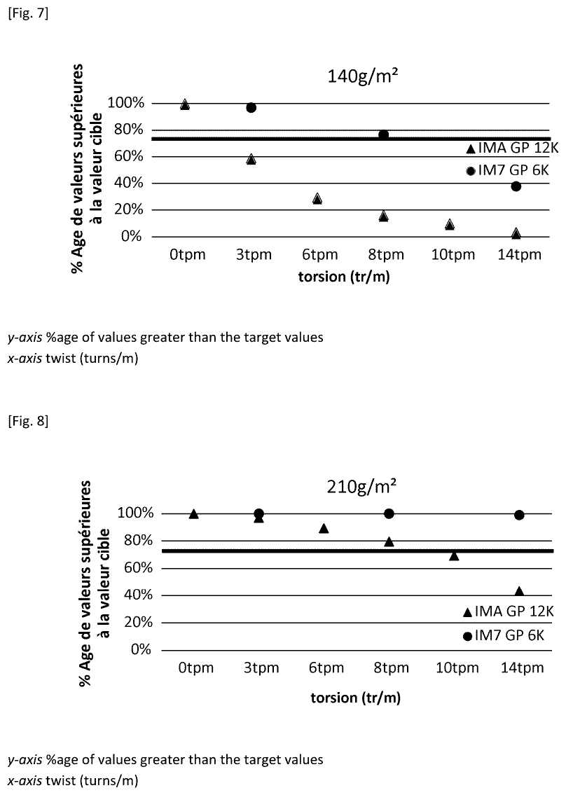

FIGS. 7 to 11 are graphs showing, for various grammages, the percentage of values above the target width value as a function of twist for various carbon yarns.

FIG. 7 shows that for a 140 g/m² web:
For IMA-12K fiber, the web can be made only of non-twisted carbon yarn;
For IM7-6K fiber, the web can be made only of carbon yarn having a twist less than or equal to 8 turns per meter.

FIG. 8 shows that for a 210 g/m 2 web:
For IMA-12K fiber, the web can be made from carbon yarns having a twist less than or equal to 8 turns per meter;
For IM7-6K fiber, the web can be made from carbon yarns having a twist of up to 14 turns per meter.

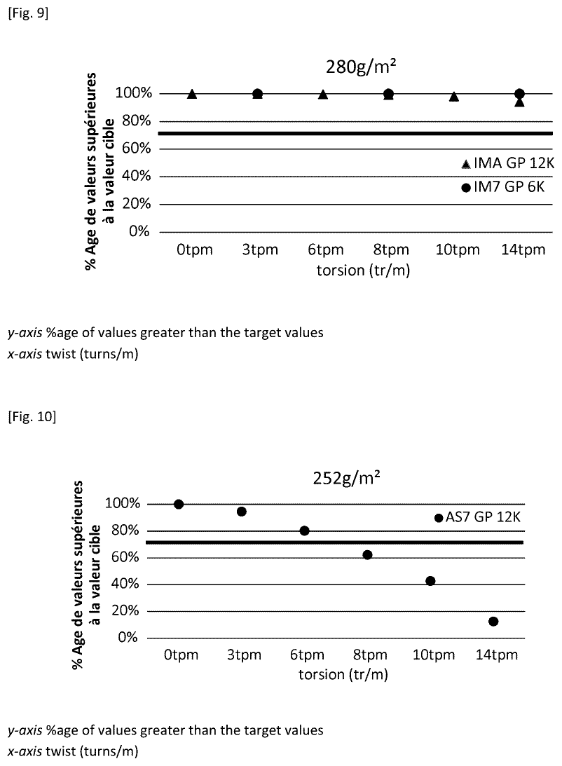

FIG. 9 shows that for a 280 g/m² web, the grammage becomes sufficiently high to use carbon yarns having all the twist values within the range.

FIG. 10 shows that for a 252 g/m² web, made of AS7-12K fiber, the web can be made of carbon yarns having a twist less than or equal to 6 turns per meter.

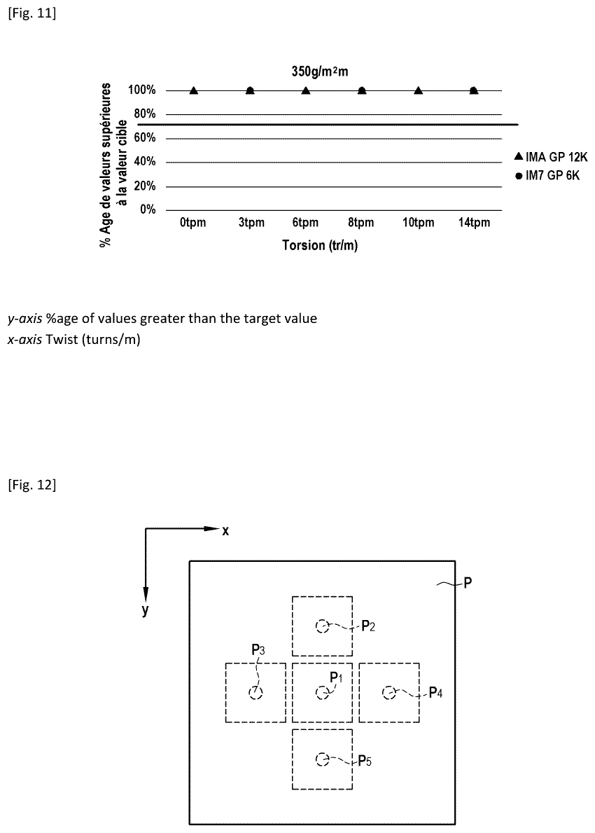

FIG. 11 shows that for a 350 g/m 2 web the grammage becomes sufficiently high to use carbon yarns having all the twist values in the range.

It thus appears possible to define the usable twist limits for each type of carbon yarn, for a given basis weight, which also makes it possible to choose not only the yarns to be used but also the twist to be applied, depending in particular on the desired grammage of the unidirectional web.

Within the scope of the invention, the unidirectional reinforcing web 2 has a grammage within the range from 126 g/m² to 1000 g/m², in particular from 126 g/m² to 500 g/m², from 126 g/m² to 420 g/m², or from 126 g/m² to 280 g/m², from 280 g/m² to 500 g/m², or from 420 g/m² or 210 g/m² to 280 g/m₂.

The grammage of the unidirectional web, within the reinforcing material, corresponds to that of the unidirectional web before its association with the porous polymeric layer or layers, typically a veil or veils, but it is impossible to measure the grammage of the unidirectional web before its association with the veils 4, 5 because the carbon yarns have no cohesion among them. The grammage of the carbon fiber reinforcing web can be determined from the grammage of reinforcing material 1 (typically the unidirectional web 2 and the two veils 4, 5). If the basis weight of the porous polymeric layer or layers present (typically, the veils) is known, it is then possible to deduce the basis weight of the unidirectional web. Advantageously, the basis weight is determined from the reinforcing material by chemical attack (or possibly also by pyrolysis) of the porous polymeric layer(s), typically of the veil(s). This type of method is conventionally used by a person skilled in the art to determine the carbon fiber content of a woven fabric or a composite structure.

A method for measuring the grammage of the reinforcing material 1 is described below. The grammage of the reinforcing material is measured by weighing cut samples of 100 cm² (that is, 113 mm in diameter). To facilitate cutting the samples of the reinforcing material, which is flexible, the reinforcing material is placed between two glossy cardboards from Cartonnage Roset (Saint Julien en Genevois, France) of 447 g/m² and of 0,450 mm thickness to ensure a certain rigidity of the assembly. A pneumatic circular punch from Novi Profibre (Eybens, France) was used to cut the assembly; 10 samples are taken per type of reinforcement product manufactured.

In general, the method for preparing the reinforcing material 1 according to the invention comprises the following successive steps:
a1) providing a unidirectional reinforcing web 2 as defined within the scope of the invention, referred to as a mixed unidirectional web S/Z,
a2) providing at least one, or two porous polymeric layers 4, 5,
a3) associating one or each of the porous polymeric layers with each of the faces of the unidirectional reinforcing web.

In general, the unidirectional reinforcing web 2 of step a1) will have a grammage equal to that desired in the final reinforcing material 1 and a width equal to the desired width of the final reinforcing material 1.

Advantageously, the preparation method comprises, upstream of step a1), a step for the production of said unidirectional reinforcing web 2 comprising, firstly, the application of a twist from 3 turns/m to 15 turns/m to a carbon yarn or to a series of carbon yarns 3 having an S-twist, said twist being individually applied to each carbon yarn 3 and, secondly, applying a twist from 3 turns/m to 15 turns/m to a carbon yarn or to a series of carbon yarns 3 having a Z-twist, said twist being individually applied to each carbon yarn 3.

In particular, the method comprises, upstream of step a1):
i) firstly, applying a twist from 3 turns/m to 15 turns/m to a yarn or a series of carbon yarns 3 having an S-twist, said twist being applied individually to each carbon 3 yarn, and secondly, applying a twist from 3 turns/m to 15 turns/m to a yarn or a series of carbon 3 yarns having a Z-twist, said twist being applied individually to each carbon yarn 3.
ii) aligning the twisted yarns thus obtained, and arranging said yarns contiguously, so as to form a unidirectional reinforcing web as defined within the scope of the invention, referred to as a mixed S/Z unidirectional web, having any of the configurations described herein.

Within the scope of the invention, the use of yarns that do not all have the same S-twist or Z-twist type as previously defined facilitates the alignment and arrangement of the yarns during step ii). Thus, in step ii), the choice of yarns that are aligned will be made so as to obtain one of the mixed S/Z unidirectional webs as described herein.

Further, within the scope of the invention, it is possible to produce the reinforcing materials by implementing the association of one or more of the porous polymeric layers on one of the faces of the unidirectional reinforcing web, in a continuous manner, by making the reinforcing material pass through a motorized conveying system or device during production.

According to an advantageous feature, the porous polymeric layer or layers 4, 5 used, which in particular can be non-woven materials, have a hot-melt quality and the association of step a3) is obtained by lay up of one or each of the porous polymeric layers present onto one or each of the faces of the unidirectional reinforcing web, said lay-up being accompanied or followed by heating the polymeric fibers, causing their softening or melting, which is then followed by cooling.

Advantageously, the unidirectional web 2 is associated, on each of its faces, with a porous polymeric layer 4, 5 to produce a reinforcing material 1, examples of which are shown in FIGS. 1A and 1C. The use of a symmetrical reinforcing material makes it possible to avoid any stacking error, during the manual or automatic lay up for the formation of composite parts, and thus to limit the generation of defects, in particular of an interply without a veil. This is the reason for, advantageously, the unidirectional web 2 being associated, on each of its faces, with a porous polymeric layer, and, in particular, with a polymeric fiber veil 4, 5, the two porous polymeric layers (typically the veils) 4, 5 being identical.

“Porous polymeric layer” means a permeable layer allowing a liquid such as a resin to pass through the material or the stack containing it during the formation of a composite part. In particular, the openness factor of such a layer, determined according to the method described in application WO 2011/086266, is within the range from 1% to 70%, preferably within the range from 30% to 60%. Examples of porous layers include porous films, scrims made by interweaving of yarns, layers obtained by powder coating, layers obtained by liquid polymer application, woven fabrics and non-woven materials. The porous layer is referred to as polymeric, as it is composed of a polymer or mixture of polymers. In particular, the porous polymeric layer can be made of one or a plurality of thermoplastic polymers, one or a plurality of thermosetting polymers, one or a plurality of partially crosslinked thermoplastic polymers, a mixture of such polymers or a mixture of thermosetting or thermoplastic polymers. Examples of thermoplastic polymers classically used in a dry stack (and thus for forming the porous layer(s) present), are chosen from: Polyamides (PA: PA6, PA12, PA11, PA6,6, PA 6,10, PA 6,12, . . . ), Copolyamides (CoPA), Polyamides—block ether or ester (PEBAX, PEBA), polyphthalamides (PPA), Polyesters (Polyethylene terephthalate-PET-, Polybutylene terephthalate PBT- . . . ), Copolyesters (CoPE), thermoplastic polyurethanes (TPU), polyacetals (POM . . . ), Polyolefins (PP, HDPE, LDPE, LLDPE . . . Polyethersulfones (PES), Polysulfones (PSU . . . ), Polyphenylenesulfones (PPSU . . . ), Polyetheretherketones (PEEK), Polyetherketoneketones (PEKK), Poly(Phenylene Sulfide) (PPS), Polyetherimides (PEI), thermoplastic polyimides, liquid crystal polymers (LCP), phenoxies, block copolymers such as Styrene-Butadiene-Methylmethacrylate (SBM) copolymers, Methyl methacrylate-Butyl methylmethacrylate (MAM) copolymers and mixtures thereof. It is also possible for the porous polymeric layer to be composed of or contain a partially cross-linked thermoplastic polymer, as described in WO 2019/102136. The choice of the constituent polymer(s) of the polymeric portion of the dry stack can be adjusted by a person skilled in the art, depending on the choice of the resin that will be injected or infused, when the composite parts are subsequently produced. Within the scope of the invention, the non-woven materials or veils, or more generally the porous polymeric layers used, advantageously have a thermoplastic nature, and, in particular, consist of a thermoplastic polymer, of a partially crosslinked thermoplastic polymer, of a mixture of such polymers, or of a mixture of thermoplastic and thermosetting polymers. The non-woven materials or veils are preferably made of a thermoplastic material mentioned above.

Within the scope of the invention, the reinforcing materials having been classified as dry, the total weight represented by the porous polymeric layer 4 or 5 present (when the reinforcing material 1 according to the invention contains only one) or the weight of all the porous polymeric layers 4,5 present (when the reinforcing material 1 according to the invention contains a plurality) represents no more than 10% of the total weight of the reinforcing material 1 according to the invention, typically from 0.5% to 10% of the total weight of the reinforcing material 1, and preferably from 2% to 6% of its total weight.

Particularly advantageous embodiments of porous polymeric layers are non-woven materials, preferably identical.

“Non-woven” or “veil” conventionally means an assembly of continuous or short fibers which may be randomly arranged. These non-woven materials or veils can, for example, be produced by drylaid, wetlaid, or spunlaid processes, for example by extrusion (“Spunbond”), meltblown extrusion (“Meltblown”), fiberized spray applicator, or solvent spinning (“electrospinning”, “Flashspinning”, “Forcespinning”), which are all well-known to a person skilled in the art. In particular, the constituent fibers of the non-woven material can have an average diameter within the range from 0.5 μm to 70 μm, and preferably from 0.5 μm to 20 μm. The non-woven materials can be made of short fibers or, preferably, continuous fibers. In the case of a non-woven material made of short fibers, the fibers can have, for example, a length of from 1 mm to 100 mm. Preferably, the non-woven materials used provide random and preferably isotropic coverage.

The thickness of the veils before their association with the unidirectional web will be chosen according to the way in which they will be associated with the unidirectional web. Usually, their thickness will be very close to the desired thickness of the reinforcing material. It is also possible to choose to use a veil of greater thickness which will be laminated under temperature during the association stage, so as to achieve the desired thickness. Preferably, the unidirectional web is associated on each of its large faces with two substantially identical veils, so as to obtain a totally symmetrical reinforcing material. The thickness of the veil before association with the unidirectional carbon web is, in particular, from 0.5 μm to 200 μm, preferably from 10 μm to 170 μm. On the reinforcing material 1 according to the invention, the thickness of each veil 4, 5 after association with the unidirectional web, is within the range from 0.5 microns to 50 microns, preferably within the range from 3 microns to 35 microns. The thickness of the various veils before association is determined by EN ISO 9073-2 using method A with a test area of 2827 mm² (60 mm diameter disk) and an applied pressure of 0.5 kPa.

Further, the basis weight of the veil(s) 4,5 is advantageously within the range from 0.2 g/m² to 20 g/m².

The association between the unidirectional web 2 and the porous polymeric layer or layers (typically non-woven material(s)) 4,5 can be achieved in a discontinuous manner, for example only at certain points or in certain zones, but is, preferably, achieved according to a connection which extends on the totality of the surface of the web, classified as continuous.

The association of the unidirectional web 2 with the two veils 4,5 is advantageously performed according to the method described in patent application WO 2010/046609 or one of the methods described in application WO 2010/061114. Continuous production machines and lines, as described in these documents, or in the examples of the invention can be used. In particular, within the scope of the invention, it is possible to produce reinforcing materials by performing the association of one or each of the porous polymeric layers on one of the faces of the unidirectional reinforcing web, continuously, and by causing the reinforcing material resulting from the said association to run through, by means of a motorized conveying system or device. Such devices are, for example, conveyor belts, driven by one or a plurality of drive rollers, between which the reinforcing material circulates, after the unidirectional web has been laid on a porous polymeric layer or between two porous polymeric layers, depending on the material produced, to ensure its or their application thereon.

Further, the association of the unidirectional web with the two veils can be accomplished by means of an adhesive layer, for example chosen from epoxy adhesives, polyurethane adhesives, thermosetting glues, polymerizable monomer-based adhesives, structural acrylic or modified acrylic adhesives, and hot-melt adhesives. However, most often, the association will be achieved by means of the hot melt quality of the veils (or more generally of the porous polymeric layers) when they are hot, for example during a thermocompression step allowing to ensure a bond between the unidirectional web and the veils. This step leads to the softening of the thermoplastic fibers of the veil, making it possible for the unidirectional web to be bonded to the veils, after cooling. The heating and pressure conditions are adapted to the material of the veils and their thickness. Usually, a thermocompression step is performed over the entire surface of the unidirectional web at a temperature ranging from Tf veil−15° C. to Tf veil+60° C. (with Tf veil designating the melting temperature of the veil) and under a pressure of 0.1 MPa to 0.6 MPa. It is thus possible to achieve compression ratios of the veil before and after association that range from 1 to 10. The step of laminating the veil onto the unidirectional carbon web 2 is also essential for properly controlling the final thickness of the reinforcing material 1. Indeed, depending on the temperature and pressure conditions, particularly during lamination, it is possible to modify, and therefore adjust, the thickness of the veil present on each side in the reinforcing material.

The reinforcing material according to the invention is easy to handle, due to the presence of one or a plurality of porous polymeric layers, and in particular thermoplastic veils laminated on each of the faces of the unidirectional web. This architecture also facilitates cutting, without fraying in particular, along non-parallel directions, in particular transverse or oblique, to the fibers of the unidirectional web.

The reinforcing materials 1 according to the invention are flexible and windable. They can be produced in long lengths corresponding to the available lengths of carbon yarn. Usually, after being manufactured, they are wound in the form of a roll around a spool, before being used for the subsequent manufacture of preforms and parts.

The invention is even more particularly relevant for reinforcing materials with a width greater than 7 mm, preferably greater than 12 mm, and more preferably within the range from 12 mm to 51 mm. Further, the invention is also particularly suitable for reinforcing materials, which have a length greater than 2 m, in particular a length from 2 m to 5000 m, preferably 100 m to 2000 m. Thus, according to preferred embodiments within the scope of the invention, the reinforcing materials according to the invention have a width greater than 7 mm and a length greater than 2 m, and advantageously a width within the range from 12 mm to 51 mm and a length within the range from 2 m to 5000 m, preferably, from 100 m to 2000 m. The width of the material is its average width, taken perpendicularly to the plane Δ, that is, taken perpendicularly to the general direction of extension of the unidirectional web: the width can be measured using any appropriate means, in particular a camera, by taking measurements every 10 cm, over the entire length of the material, and by taking the arithmetic average of the measurements obtained. The length of the material is preferably measured at the level of the plane Δ. In particular, the width of the reinforcing material 1 can be measured by making it run at a constant speed of 1.2 m per minute, with a constant tension from 200 cN to 400 cN, and by making it pass, at a distance of 265 mm and without support at this point, in front of a camera, for example of the type Baumer Optronic Type FWX 20, focal length 20 mm, 1624×1236 pixels (Baumer Optronic Gmbh, Germany—the calibration of the camera is as follows: 1 pixel is equivalent to 0.05 mm) or another camera suitable for larger widths of reinforcing material.

For the production of composite parts, a stack or lay-up of reinforcing materials (also referred to as plies) is made according to the invention. Conventionally, a material according to the invention is cut to the desired size for the production of the part, ply, stack, or preform to be made. In a stack, a plurality of plies of reinforcing material are stacked on top of each other.

A ply can be made of a single reinforcing material according to the invention, when the reinforcing material has a sufficient width for the production of the desired part and the part is not exceptionally complex. But usually, in the case of large or complex parts, a ply consists of an assembly of reinforcing materials 1 according to the invention which are arranged contiguously, to cover the entire surface necessary to produce the desired part. In this case, precise placement of the reinforcing material must be achieved. In automated processes, the devices for conveying and applying the reinforcing materials comprise one or a plurality of guide members or guides wherein the reinforcing material is conveyed and transported. Devices comprising lay-up heads equipped with such guide members or guides are, in particular, described in documents WO 2006/092514 and EP 2 376 276. The companies Coriolis Composites SASU (rue Condorcet 56530 Queven, France), MTorres Disenos Industriales SAU (Torrez de Elorz, Navarra, Spain), Electrolmpact Inc (Mukilteo WA 98275, United States), Mikrosam DOO (7500 Prilep Macedonia) also provide such devices. Within the scope of the invention, it was found that centering reinforcing materials 1 according to the invention comprising a mixed S/Z unidirectional web, and in particular one of those more precisely described within the scope of the invention, leads to more precise placement and thus to a reduction in the likelihood of defects such as gap, overlap, wrinkle or corrugation during lay-up. Thus, parts made of reinforcing materials 1 according to the invention comprising a mixed S/Z unidirectional web, and in particular one of those more precisely described within the scope of the invention, are particularly satisfactory.

Further, in order to produce a composite part, a plurality of plies, one on top of the other, are made to result in a stack of plies. Thus, the imperfections on the reinforcing materials 1 are reproduced in each ply and are thus accentuated on a stack. It is for this reason that, again, reinforcing materials 1 according to the invention comprising a mixed S/Z unidirectional web which have more even, and reproducible features are particularly advantageous. In the resulting stack, the plies are generally arranged, so that at least two unidirectional webs of the plies are oriented in different directions. From one ply to another, all the unidirectional webs or only some of them can have different directions, while the others can have identical directions. The preferred orientations are usually in the directions making an angle of 0°, +45° or −45° (also corresponding to)+135°, and +90° with the main axis of the part to be produced. The main axis of the part is generally the largest axis of the part and the 0° is merged with this axis. It is, for example, possible to make quasi-isotropic, symmetrical, or oriented stacks by choosing the orientation of the plies. Examples of quasi-isotropic stacking include stacking according to the angles 45°/0°/135°/90°, or 90°/135°/0°/45°. Examples of symmetrical stacking include 0°/90°/0°, or 45°/135°/45°. Before adding the resin necessary to produce the part, it is possible to join the plies together within the stack, in particular by an intermediate step of preforming under temperature and vacuum or welding at a few points after each addition of a ply, and thus produce a preform. In particular, the assembly of 2 to 300 plies, in particular 16 to 100 plies, can be considered.

Advantageously, the stack is not attached by sewing or knitting, but instead by a weld made by the polymeric, and, in particular, the thermoplastic properties of the porous polymeric layers present within the stack. For this purpose, a heating/cooling operation is performed over the entire surface of the stack or at least in some zones of the stack surface. Heating causes the polymeric porous layers to melt or to at least soften. Such bonding using the thermoplastic nature of the polymeric porous layers is advantageous, because it makes it possible to avoid all the disadvantages that the presence of sewing or knitting yarns present, such as in particular the problems of corrugation, microcracking, and the reduction of the mechanical properties of the composite parts subsequently obtained.

Stacking can be achieved by adding each ply one at a time and ensure bonding after the addition of each ply. In particular, one example is automated ply lay-up as described in patent applications WO 2014/076433 and WO 2014/191667. Also, all the applied plies (by prior heating of the plies one at a time or without heating) can be entirely heated again in order to obtain, for example, a shaped preform from plies laid flat. A person skilled in the art can then use the conventional means of hot forming, with application of temperature and pressure (vacuum or press system for example). In particular, the lay-up of a reinforcing material according to the invention can be performed continuously with the application of pressure perpendicular to the laying surface in order to apply it thereto, according to methods known by the abbreviations AFP (Automated Fiber Placement) or ATL (Automated Tape Lay-up) for example as described in the aforementioned documents WO 2014/076433 A1 and WO 2014/191667.

In order to produce composite parts, a resin or matrix of the thermosetting or thermoplastic type or a mixture of thermosetting and thermosetting resins is then added, for example by injection into the mold containing the plies (Resin Transfer Molding (RTM) process), or by infusion (through the thickness of the plies: Liquid Resin Infusion (LRI) process or Resin Film Infusion (RFI) process). According to a non-preferred embodiment, it is also possible to perform, before the stacking, manual coating/impregnation by means of a roller or a brush, on each of the plies, applied successively on the form of the mold used.

The matrix used is of the thermosetting or thermoplastic type or a mixture of thermoplastic and thermosetting resins. The injected resin is, for example, chosen from the following thermosetting polymers: epoxides, unsaturated polyesters, vinyl esters, phenolics, polyimides, and bismaleimides.

The composite part is then obtained after a heat treatment step. In particular, the composite part is generally obtained by means of a conventional hardening cycle of the polymers considered, by performing a heat treatment, as recommended by the suppliers of these polymers, and known to a person skilled in the art. This hardening step of consolidation of the desired part is performed by polymerization/crosslinking according to a defined cycle in temperature and under pressure, followed by cooling. The pressure applied during the treatment cycle is low in the case of vacuum infusion and higher in the case of injection into an RTM mold.

Methods for bonding the stack described above can also be implemented with any type of reinforcing material intended to be associated with a thermosetting resin for the production of composite parts, which are made of a unidirectional carbon fiber web associated, on each of its faces, with a thermoplastic fiber veil and in particular with reinforcing materials other than those defined in the claims of the present patent application. Indeed, irrespective of the unidirectional webs and veils used, such stacks are valuable in terms of drapability and permeability. Of course, preferably, the reinforcing materials are in accordance with, in terms of thickness and grammage, those described within the scope of the invention, given that they make it possible to achieve high fiber volume ratios (FVR), by means of vacuum infusion.

The following examples illustrate the invention but are not intended to be limiting.

PART A

A first series of tests was performed to yield the data presented in Table 3 below. In this series of tests, the so-called twisted materials had only twisted S-twist yarns.

TABLE 3

| | | Comparative | Material | Material | |
|---|---|---|---|---|---|
| | | Material | 2 | 3 | |
| Material | | 1 | twisted | twisted | |
| Reinforcing fibers | | Hexcel IMA 12 K | | | |
| Polymeric binder | | 1R8 4 g/m² per face | | | |
| Width of the web | | 6.35 mm | | | |
| Number of carbon yarns | | 4 | 4 | 4 | |
| Basis weight of UD | | | 280 | 280 | |
| reinforcing fibers (g/m²) | | | | | |
| Micro-perforation | | Yes | No | No | |
| Twisting | Yes/No | No | Yes | Yes | |
| | Number of | | 10 | 8 | |
| | turns/meter | | | | |
| | Number of | | All | All | |
| | twisted yarns | | | | |
| | Twisting | | S | S | |
| | direction | | | | |
| | | Material | Material | Material | |
| | | 4 | 5 | 6 | Material |
| Material | | twisted | twisted | twisted | 7 |
| Reinforcing fibers | | Hexcel IMA 12 K | | | |
| Polymeric binder | | 1R8 4 g/m² per face | | | |
| Width of the web | | 6.35 mm | | | |
| Number of carbon yarns | | 5 | 5 | 6 | |
| Basis weight of UD | | 350 | 350 | 420 | |
| reinforcing fibers (g/m2) | | | | | |
| Micro-perforation | | No | No | No | No |
| Twisting | Yes/No | Yes | Yes | Yes | Yes |
| | Number of | 14 | 14 | 10 | 20 |
| | turns/meter | | | | |
| | Number of | All | All | All | All |
| | twisted yarns | | | | |
| | Twisting | S | S | | |
| | direction | | | | |

| | Com- |
|---|---|
| | parative |
| Material | material |

| | | | |
|---|---|---|---|
| Material | Material 8 | 9 | 10 |

| Reinforcing fibers | | Hexcel IMA 12 K | | |
|---|---|---|---|---|
| Polymeric binder | | 1R8 4 g/m² per face | | |
| Width of the web | | 6.35 mm | | |
| Number of carbon yarns | | 4 | 5 | 5 |
| Basis weight of UD | | 280 | 280 | 350 |
| reinforcing fibers (g/m2) | | | | |
| Micro-perforation | | No | No | No |
| Twisting | Yes/No | Yes | Yes | Yes |
| | Number of | 30 | 20 | 30 |
| | turns/meter | | | |
| | Number of | All | All | All |
| | twisted yarns | | | |
| | Twisting | S | S | S |
| | direction | | | |

In Table 3 above, the tested reinforcing materials comprise unidirectional reinforcing webs associated with a veil on each side.

12K Intermediate Modulus (IM) carbon yarns marketed by HEXCEL Corporation, Stamford, CT, USA were used in the unidirectional reinforcing web. Comparative material 1 uses such carbon yarns which are non-twisted, but are micro-perforated, after association of the unidirectional web with the veils. Materials 2 to 6 are reinforcing materials wherein the unidirectional web consists of individually twisted carbon yarns as described above (twisted yarns) having a twist value according to the invention, with all having an S-twist, which does not correspond to the invention. The comparative materials 7 to 10 are reinforcing materials made of twisted yarns having a greater twist than that envisioned by the invention and cannot be made, because the material separates either at the production stage or at the handling or lay-up stage, thus rendering it unusable.

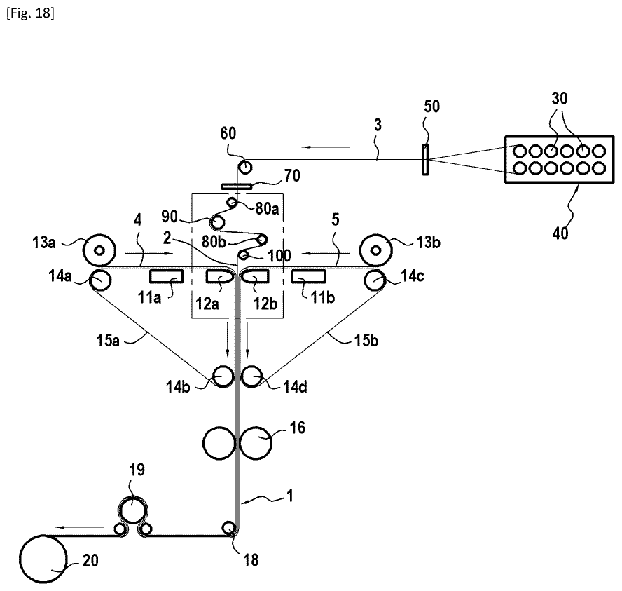

For porous polymeric layers selected from non-woven materials, the 4 g/m2 copolyamide non-woven material 1R8 D04 marketed by Protechnic was used. The veils were associated with the unidirectional carbon yarn web according to patent application WO 2010/046609. More precisely, the reinforcing materials 1 according to the invention were made on a production line using a machine and the parameters as described in application WO 2010/061114 and described below, with reference to FIG. 18.

Carbon yarns 3 having the desired twist were unwound from corresponding spools 30 of carbon yarns attached to a creel 40, passed through a comb 50, fed into the axis of the machine by means of a guide roller 60, a comb 70, and a guide bar 80a.

Carbon yarns 3 were preheated by means of the heating bar 90 and then spread by means of the spreading bar 80b and the heating bar 100 to the desired carbon basis weight for the unidirectional web 2. The rolls 13a and 13b of veils 4,5 are unrolled without tension and transported by means of continuous belts 15a and 15b secured between the free rotating, non-motorized rolls 14a, 14b, 14c, and 14d and the heated bars 12a, 12b.

Veils 4 and 5 were preheated in zones 11a and 11b before coming into contact with carbon yarns 3 and laminated on either side of two heated bars 12a and 12b wherein the air gap is controlled. A calender 16, which can be cooled, then applied pressure to the unidirectional web having a veil on each side, to produce the reinforcing material 1 in the form of a tape. A deflection roller 18 makes it possible for the reinforcing material 1 to be redirected to the traction system comprising a motor-driven take-up trio 19 and then to a winding arrangement 20 to form a roll of the reinforcing material 1 thus formed.

It should be noted that, on this production line, the belts are not motorized but are instead pulled by the reinforcing yarns 3 themselves.

Further, as explained in application WO 2010/061114 and presented in its FIG. 8, a plurality of reinforcing materials according to the invention, having the form of tapes, were manufactured simultaneously. Each twisted carbon yarn forming the unidirectional web to be formed was drawn from a roll of the selected twisted yarn that had been previously manufactured. Unidirectional webs of the desired width were made, in parallel, with the selected number of yarns, and were spaced so as to leave sufficient space between each unidirectional web. A single non-woven fabric (corresponding to veils 4 and 5) covering the various unidirectional webs 2 and the gaps was therefore associated with all the unidirectional webs 2 on each of their faces. The non-woven materials, after they had been laminated to the webs, were then cut between each unidirectional web formed by means of heated cutting elements, thus resulting in various reinforcing materials according to the invention, which were produced contiguously. The gap between each unidirectional web was within the range from 0.5 mm to 2 mm, so that cutting between each unidirectional web along its edges could be carried out, resulting in various reinforcing materials, produced continuously and in parallel.

1) Thickness Under Vacuum:

During automated lay-up of complex shapes or a thick preform, it is important to have a material that overruns as little as possible, and thus to have an applied material thickness close to the final thickness of the composite part. Indeed, if the material presents a significant overrun, thus having a thickness much greater than the final thickness after manufacture of the laminate, significant defects will be present on the part. The defects will be mainly due to over-lengths and will generate wrinkles. This is unacceptable to a person skilled in the art. In order to characterize this property, the thickness of a preform is measured after automated lay-up before and after placement under vacuum.

As shown in FIG. 12, 200×200 mm preforms P were formed having a quasi-isotropic symmetrical stack, more precisely having the lay-up [+45/0/−45/90]3s. The preform P was placed on a plate. A FANUC robot and a HEIDENHAIN/ST3077 LVDT probe were used to measure the thickness. The tip of the probe is a 50 mm diameter circular key. The probe measures the thickness of the preform at 5 points P1 to P5, which then makes it possible to obtain an average thickness value for the preform. A measurement was made every 50 mm along the x-axis and 50 mm along the y-axis.

The preform was then placed under vacuum (residual pressure lower than 15 mbar) using a vacuum bag and a pump. The thickness of the assembly was then measured, and the thickness of the consumables subtracted to obtain the thickness of the preform under vacuum.

The ratio of the thickness without vacuum to the thickness under vacuum was then calculated. The higher the ratio, the greater the thickness without vacuum compared to the thickness under vacuum and the greater the likelihood of defects on the final part. The goal is to minimize this ratio.

Table 4 below summarizes the ratio of the thickness (vacuum-free thickness) divided by the theoretical thickness (thickness under vacuum) for materials 1 to 6.

TABLE 4

| | Comparative | Material | Material | Material | Material | Material |
|---|---|---|---|---|---|---|
| Material | material 1 | 2 twisted | 3 twisted | 4 twisted | 5 twisted | 6 twisted |
| Ratio of thickness divided | 1.49 | 1.26 | 1.26 | 1.28 | 1.32 | 1.23 |
| by theoretical thickness | | | | | | |
| for 60% FVR | | | | | | |

As compared to material 1 of the prior art, the materials 2 to 6 using twisted yarns make it possible to minimize the ratio of the vacuum-free thickness to the thickness under vacuum. This in turn makes it possible to reduce the overrun.

2) Effect of Twisting on the Quality of Automated Lay-Up.

It is essential that the automated lay-up step on the preform not create defects therein. The architecture of the carbon yarn can affect the quality of the lay-up. Thus, it is necessary to determine if the twisting of the carbon yarns has an impact on the quality of the preform after lay-up.

More precisely, the twisting of the carbon yarns can have an effect on the so-called “shearing” phenomenon. During the superimposed lay-up of reinforcing materials (unidirectional web 2 and veils 4, 5), the carbon yarn of a ply located just below the next ply is subjected to shearing, due to the pressure and the movement of the robot head during lay-up. This shear is most prevalent in the area where lay-up is started. As several plies are laid up, this intra-ply shear can intensify, which results in a local increase in the preform thickness and the appearance of defects (such as wrinkles, fraying, ply separation, and the like) which results in poor preform quality.

An industrial-type automated ply lay-up test was performed with twisted carbon yarns. A Coriolis Cl robot equipped with a Coriolis 16¼″ AFP head and a 12 kw laser type heating arrangement was used to perform the lay-up. In this particular case, only 8 of 16 webs were laid at the same time, contiguously. The heating law followed is described in Table 5 below.

TABLE 5

| | V min | V max | P min | P max |
|---|---|---|---|---|
| | (m/s) | (m/s) | (W) | (W) |
| Heating Law 1st ply | 0.01 | 0.6 | 250 | 800 |
| Heating Law X plies (X > 1) | 0.01 | 0.6 | 180 | 680 |

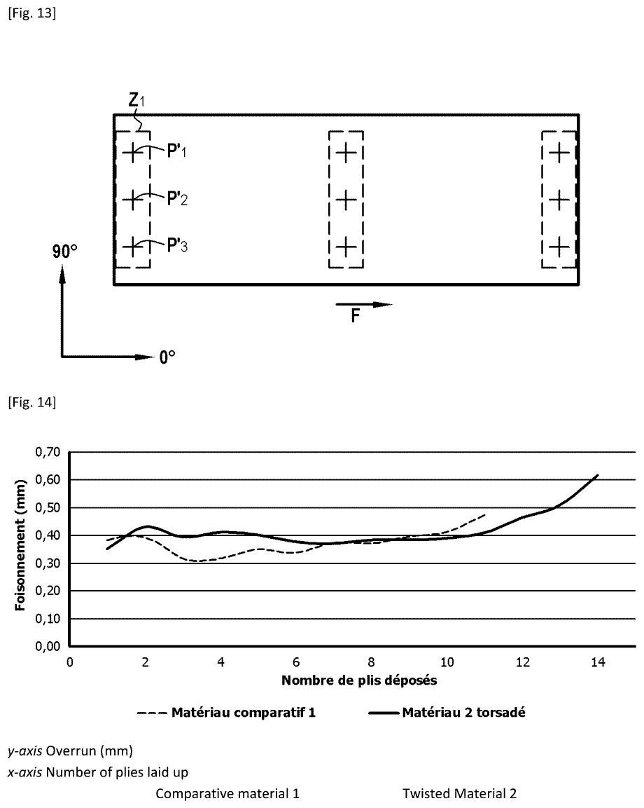

Plies of twisted carbon yarns were successively laid up at 0° on a vacuum table to form a 500 mm (in the 0° direction) by 150 mm preform. The beginning of the carbon yarn laying, which is done according to the laying direction represented by the arrow F, is always located at the same place on the preform (rectangular zone Z1 on FIG. 13). Thus, the thickness studied was located in this zone Z1.

After the lay-up of each ply, thickness measurements at the lay-up start zone (points P′1, P′2, P′3 inside the zone Z1) of the preform were performed by means of a marking gauge, a support consisting of aluminum bars and a weight of 1 kg, representing a pressure of 0.02 bar applied to the preform at the time of the thickness measurement. During the measurement, the thickness measuring device was always positioned at the same place. After each ply lay-up, it was removed in order to make it possible for the robot to pass and then to be repositioned after the lay-up. The lay-up is stopped when the quality of the preform is judged to be unsatisfactory.

Material 2 (Table 3) is compared to comparative material 1.

FIG. 14 shows the change in the overrun as a function of the number of plies laid up for comparative material 1 and material 2.

Note that overrun is defined as the ratio of the total thickness of the preform with X plies laid up to the number of laid up plies X, or:

Overrun (in mm)=total thickness of the preform (in mm)/number of plies laid up

This gives an indication of the average thickness of a ply and thus makes it possible to quantify the overrun phenomenon. To maximize the overrun phenomenon, a stack of reinforcing materials consists of unidirectional layers extending at 0°.

As shown in FIG. 14, the change in thickness per ply as a function of the number of plies laid up is lower with twisted carbon yarns (material 2) than with the micro-perforation process (comparative material 1). According to the results, with twisted carbon yarns, there is a reduction in overrun and a better quality of the preform after lay-up compared to an equivalent material made with non-twisted carbon yarns and micro-perforated according to the prior art.

3) Effect of Twisting on the Transverse Permeability of the Reinforcing Material:

It is important to validate that the present invention maintains the same level of transverse permeability of the reinforcing material as that obtained with the micro-perforated reinforcing material according to the prior art. This can be defined as the ability of a fluid to pass through a fibrous material. It is measured in m2. The values given below in Table 6 were measured with the apparatus and the measurement technique described in the thesis entitled “Problematique de la mesure de la permeability transverse de preformes fibreuses pour la fabrication de structures composites” [Measuring the transverse permeability of fibrous preforms for the manufacture of composite structures], by Romain Nunez, defended at the Ecole Nationale Superieure des Mines de Saint Etienne, on Oct. 16, 2009, which can be consulted for further details.

In particular, the measurement is performed by monitoring the thickness of the sample during the test using two co-cylindrical chambers making it possible to reduce the effect of “race-tracking” (passage of the fluid next to or “on the side” of the material for which the permeability is to be measured). The fluid used is water and the pressure is 1 bar+/−0.01 bar. Preforms of diameter 270 mm were made having a symmetrical quasi-isotropic stacking, [+45/0/135/90] S, 8 plies.

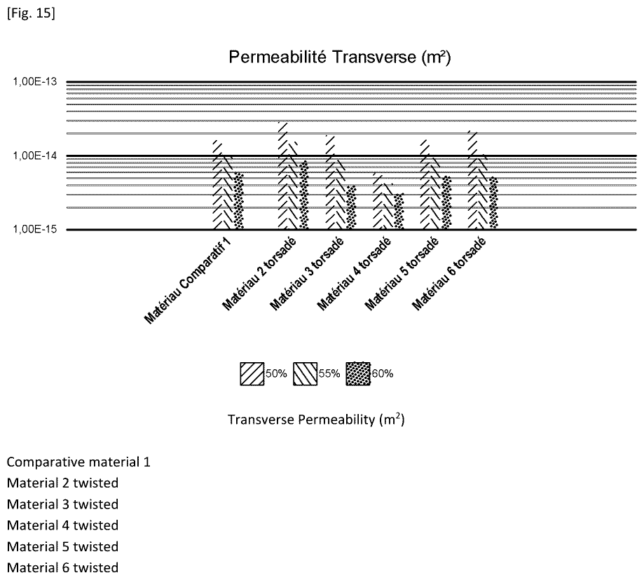

Table 6 below provides the transverse permeability values measured for fiber volume ratios (FVR) of 50%, 55% and 60% on the comparative material 1, as well as on materials 2 to 6 using twisted yarns (see Table 3). The transverse permeability values from Table 6 for the three samples with different fiber volume ratios for each material are summarized in FIG. 15.

TABLE 6

| | | Comparative | Material | Material |
|---|---|---|---|---|
| | | material | 2 | 3 |
| Material | | 1 | twisted | twisted |
| Transverse | 50% | 1.61E−14 | 2.83E−14 | 1.88E−14 |
| permeability | 55% | 9.79E−15 | 1.55E−14 | 8.66E−15 |
| (m2) | 60% | 5.97E−15 | 8.55E−15 | 3.98E−15 |
| | | Material | Material | Material |
| | | 4 | 5 | 6 |
| Material | | twisted | twisted | twisted |
| Transverse | 50% | 5.79E−15 | 1.64E−14 | 2.17E−14 |
| permeability | 55% | 4.21E−15 | 9.39E−15 | 1.05E−14 |
| (m2) | 60% | 3.06E−15 | 5.37E−15 | 5.10E−15 |

For a carbon fiber grammage of 280 g/m², twisting the carbon yarns at 10 turns per meter appears to yield better average transverse permeability than for a material that is micro-perforated according to the prior art.

For a carbon fiber grammage of 350 g/m², twisting the carbon yarns at 14 turns per meter appears to yield an average transverse permeability that is equivalent to that of a material that is micro-perforated according to the prior art.

When the number of turns per meter decreases (material 3 compared to material 2), the transverse permeability of the material decreases.

4) Effect of Carbon Yarn Twisting on the Mechanical Properties of the Composite:

Preforms of 430 mm×430 mm consisting of a stacking sequence appropriate for the carbon weight were placed in an injection mold under pressure. A frame of known thickness surrounding the preform was used to achieve the desired FVR (fiber volume ratio). The epoxy resin marketed by HEXCEL Corporation, Stamford, CT, USA with the reference HexFlow RTM6 was injected at 80° C. under 2 bars through the preform which was maintained at 120° C. inside the press. The pressure applied by the press was 5.5 bars. When the preform was filled and the resin came out of the mold, the outlet pipe was closed and the curing cycle started (3° C./min to 180° C. followed by a 2-hour post-cure at 180° C. and cooling at 5° C./min).

Specimens were then cut to the appropriate size to perform the open hole (OHC) and solid plate (UNC) compression tests summarized in Table 7 below.

TABLE 7

| | UNC | OHC |
|---|---|---|
| Ply | [45/0/135/90]3 s | [45/0/135/90]3 s |
| orientation | (for grammage 210 g/m2) | (for grammage 210 g/m2) |
| on the | [45/0/135/90]2 s (for | [4S/0/135/90]2 s (for |
| preform | grammage 280 g/m2 | grammage 280 g/m2 |
| | or 350 g/m2) | or 350 g/m2) |
| Test | Zwick Z300 | Zwick Z300 |
| machine | | |
| EN | 6036 | 6036 |
| Standard | | |

The tests were performed with reinforcing materials 2 through 5 and comparative material 1 (Table 3). The results of the open hole compression (OHC) tests are shown in Table 8 below.

TABLE 8

| OHC | Comparative | Material | Material | Material | Material |
|---|---|---|---|---|---|
| (dry, | material | 2 | 3 | 4 | 6 |
| 23° C.) | 1 | twisted | twisted | twisted | twisted |
| Stress | 276 | 281.5 | 283.1 | 268.7 | 251 |
| (MPa) | | | | | |

In the prior art it is known that the carbon weight can affect the mechanical properties. In general, the higher the carbon weight, the lower the mechanical compression properties. In the present case, the results are compared to carbon iso-grammage.

For a grammage of 210 g/m², there is no difference between results of open hole compression tests (OHC) for the comparative material and the so-called twisted materials. The same conclusions can be drawn for the 280 g/m² grammages. As for the 350 g/m² grammages, it is not possible to make comparisons with a micro-perforated material, as this option is impossible.

Results of the solid plate compression tests (UNC) are shown in Table 9 below.

TABLE 9

| UnC | Comparative | Material | Material | Material | Material |
|---|---|---|---|---|---|
| (dry, | material | 2 | 3 | 4 | 6 |
| 23° C.) | 1 | twisted | twisted | twisted | twisted |
| Stress | 487.1 | 516.7 | 531.4 | 485.5 | 444 |
| (MPa) | | | | | |

The results in Table 9 allow the same conclusions to be drawn as for the open hole tests.

5) Effect of Carbon Yarn Twisting on Transverse Electrical Conductivity:

Preforms of 335 mm×335 mm were made of reinforcing plies, the number of which depends on the grammage of the carbon yarns. The stacking sequence is [0/90] ns, with ns being an integer that depends on the grammage of the carbon yarns in order to yield a panel having a final thickness of 3 mm and 60% fiber volume. The preforms were then placed in an injection mold under pressure. In the same way as for the mechanical compression tests (see paragraph 4 above), composite panels of reinforcing material/RTM6 are made by means of an injection process (same parameters as for the compression plates).

A waterjet cutter was used to pre-cut 24 40 mm×40 mm specimens evenly distributed throughout the panel. Both surfaces of the pre-cut panel were then sandblasted to expose the carbon fibers. Next, the front and back sides of the panel were treated before applying a layer of conductive metal, typically tin and zinc by means of an electric arc process. The metal coatings should be removed from the specimen fields by sandblasting or sanding. This conductive metal application allows for low contact resistance between the sample and the measuring instrument. The individual specimens were then cut out of the panel.

A power source (TTi EL302P programmable 30V/2A power supply, Thurlby Thandar Instruments, Cambridge UK) capable of varying current and voltage was used to determine resistance. The sample was in contact with the two electrodes of the power supply; these electrodes being placed into contact by means of a clamp. Care must be taken to ensure that the electrodes do not come into contact with each other or with any other metallic element. A current of 1 A was applied and the resistance was measured by two other electrodes connected to a voltmeter/ohmmeter. The test was performed on each sample to be measured. The conductivity value was then calculated from the resistance value using the dimensions of the sample and the following formulae:

Resistivity (Ohm·m)=Resistance (Ohm)×Surface (m²)/Thickness (m)

Conductivity (S/m)=1/Resistivity

Part B

The results of a second series of tests are presented in Table 10 below. Materials 12, 13, 15, and 17 were produced according to the invention. None of the materials obtained was micro-perforated with the exception of comparative material 19.

TABLE 10

| | | | | Material 13 | Material | |
|---|---|---|---|---|---|---|
| Material | | Material 11 | Material 12 | invention | 14 twisted | Material 15 |
| Reinforcing fibers | | Hexcel IM7 12 K | | | Hexcel IMA-12 K | |
| Polymeric binder | | 1R8 4 g/m2 per face | | | | |
| Width of web | | 6.35 mm | | | 12.7 mm | |
| Number of carbon yarns | | 4 | | | 6 | |
| Basis weight of UD | | 280 | | | 210 | |
| reinforcing fibers (g/m2) | | | | | | |
| Micro-perforation | | No | No | No | No | No |
| Twisting | Number of turns | 10 | | | 8 | |
| | per meter | | | | | |
| | Number of yarns | All | | All | | |
| | twisted | | | | | |
| | Twisting direction | All S | SZZS | SZSZ | All | SZSZSZ |

| | | | | |
|---|---|---|---|---|
| | Material | Material 17 | | Comparative |
| Material | 16 twisted | invention | Material 18 | material 19 |

| | | | |
|---|---|---|---|
| Reinforcing fibers | Hexcel IMA 12 K | Hexcel IMA 12 K | Hexcel IMA 12 K |

| | |
|---|---|
| Polymeric binder | 1R8 4 g/m2 per face |

| Width of web | | 12.7 mm | | 38.1 mm | 12.7 mm |
|---|---|---|---|---|---|
| Number of carbon yarns | | 6 | | 18 | 6 |
| Basis weight of UD | | 210 | | 210 | 210 |
| reinforcing fibers (g/m2)) | | | | | |
| Micro-perforation | | No | No | No | Yes |
| Twisting | Number of turns | 8 | | 8 | NA |
| | per meter | | | | |
| | Number of yarns | All | | All | NA |
| | twisted | | | | |
| | Twisting direction | All Z | SSZZSS | 7 S yarns, 5 Z | NA |
| | | | | yarns and 6 S yarns | |

Manufacture of Reinforcing Materials According to the Invention

This second series of tests was performed on a new production line that meets the requirements of industrial scale production, which has higher production rates, with the aim of reducing stoppages of the production line and wear of its constituent parts, as well as increasing safety levels. Such increases in rate increase the overall inertia of the line, generate a greater number of frictional events for the materials on the various points/rollers of the line, and thus notably on the force necessary to drive the belts. Consequently, the production line previously described in relation to FIG. 18, was modified by introducing motorization of the continuous belts 15a and 15b. The belts 15a and 15b were motorized independently of each other by means of rollers 14a and 14c, the rollers 14b and 14d remaining free to rotate.

This increase in production rates highlights the difficulties encountered in the production of unidirectional webs with a minimized presence of defects such as gaps between yarns, overlapping or corrugation, with the use of twisted reinforcing yarns all having the same type of S-twist or Z-twist. Indeed, despite the use of a comb or a guide roller, the trajectory of the reinforcing yarns is not totally controlled, which results in the appearance of defects. These risks can be minimized and even avoided, by using mixed S/Z unidirectional webs, as proposed within the scope of the invention.

Several materials 11 were manufactured in parallel on this industrial-scale production line and therefore had higher production rates.

As in the first series of tests, a plurality of reinforcing materials according to the invention, in the form of tapes, were manufactured simultaneously.

Similarly, a plurality of materials 12 and a plurality of materials 13 according to the invention were manufactured in parallel. It was observed that the materials 12 and 13 obtained, as compared to the materials 11, were more regular, especially at the edges. Indeed, quality of yarn alignment was better during the formation of the unidirectional webs, in the case of materials 12 and 13. As a result, the distance between two unidirectional webs manufactured contiguously was more regular, thereby facilitating, between two formed unidirectional webs, cutting the two laminated veils on both faces thereof.

The same observation was made for materials 14 and 15, and 16 and 17. In the case of material 14, which comprises only S-twist yarns, more defects, such as wrinkles, gaps, or overlaps between yarns, and irregularities at the edges, were observed than for material 15, which uses a sequence of SZSZSZ yarns. Similarly, in the case of material 16, which comprises only Z-twist yarns, more defects such as wrinkles, gaps or overlaps between yarns, and irregularities at the edges, were observed than for material 17, using a sequence of SSZZSS yarns.

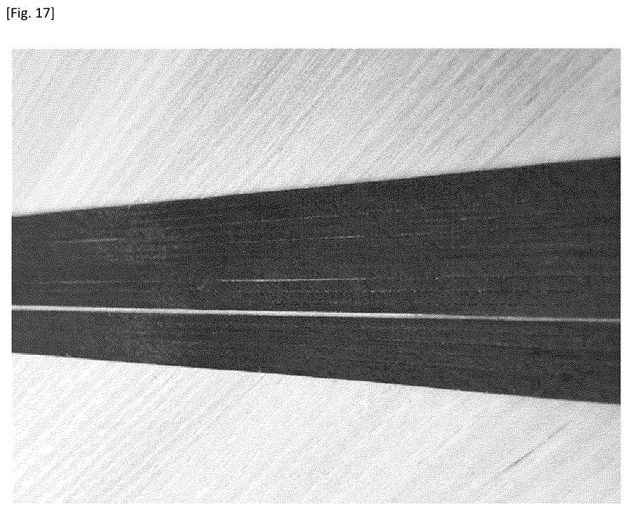

Further, in the case of material 18 comprising 18 yarns, having the sequence 7 S-twist yarns, 5 Z-twist yarns, then 6 S-twist yarns, forming a unidirectional web by the process previously described resulted in the unidirectional web as shown in FIG. 17. As can be seen in this figure, there is a marked gap at the junction of 7 S-twist yarns/5 Z-twist yarns, which constitutes a quality defect with the creation of a continuous gap along the entire length of the web, greater than 1 mm wide. The group of Z-twist yarns is drawn to the right, while the groups of S-twist yarns are drawn to the left. This results in an unsatisfactory continuous gap. This sequence does not correspond to the definitions P1, P2, I1 and I2 for mixed S/Z unidirectional webs given within the scope of the invention, which results in unidirectional webs that are more balanced in terms of the number of S-twist and Z-twist yarns and have a greater coverage due to a reduction in the risk of inter-yarn gaps.

Thus, within the scope of the invention, deflection phenomena were observed for the trajectory of the reinforcing yarns during the formation of unidirectional webs of twisted reinforcing yarns having the same twist or having configurations that do not correspond to the definitions P1, P2, I1, and I2 for mixed S/Z unidirectional webs, given within the scope of the invention, despite the use of guiding devices or combs. These phenomena do not occur for unidirectional webs comprising only 3 or fewer yarns. The use of mixed S/Z unidirectional webs proposed within the scope of the invention solves the problem for unidirectional webs consisting of more than 3 yarns.

Moreover, the deflection phenomena are exacerbated with an increase in the width of the reinforcing materials produced. The problem is even more pronounced for the production of widths greater than 7 mm, or 12 mm. The problems of deflection of the reinforcing yarns, which are solved by the mixed unidirectional S/Z webs proposed within the scope of the invention, arise regardless of the polymeric porous layer used, and irrespective of the manufacturing method used, i.e., whether a plurality of reinforcing materials is manufactured in parallel or not. Indeed, the deflection phenomena, if they do occur, also cause difficulties during the application of the materials according to the invention, resulting in an unsatisfactory positioning.

Automated Lay-Up of Reinforcing Materials According to the Invention

Materials 11 to 17 were laid up by means of an automated lay-up device, comprising a guide made of a guide groove wherein the material circulates, before being applied to the laying surface. This guide makes it possible to ensure that the web is properly positioned at the outlet of the lay-up head of the device, which then makes it possible, for the lay-up head to properly control the trajectory of the reinforcing material and its positioning on the laying surface. As shown in FIG. 16, for the evaluation of the materials, a lay-up was performed on a planar surface, by applying one next to the other, in order to obtain a joint lay-up, of a series of parallel strips of material 11 (SSSS). The same procedure was followed with material 12 (SZZS) and material 13 (SZSZ). With these two materials, the lay-up is better controlled, which results in a reduction of the gaps and corrugations on the laying surface, as it appears in the photographs as shown in the left part of FIG. 16. By observing the behavior of the materials within the guide groove, it was noted that improper centering of the material 11 (SSSS) occurred, so that is abutted on one of the edges of the groove, whereas the materials 12 and 13 were quite well centered in the groove and supported on their two edges (SSSS).

The same findings were observed firstly for materials 14 and 15, and secondly for materials 16 and 17. In the case of material 14 which comprises only S-twist yarns, the lay-up is not as satisfactory, compared to the use of material 15, using a sequence of SZSZSZ yarns. Similarly, in the case of material 16 comprising only Z-twist yarns, more gaps were observed than in the case for material 17, using a series of SSZZSS yarns. Table 11 shows the average gap width obtained between two strips, measured with a ruler, in the case for lay-up of materials 16 and 17.

TABLE 11

| Material | 17 (SSZZSS) | 16 (ZZZZZZ) |
|---|---|---|
| Number of strips applied | 8 | 8 |
| Average gap (mm) | 0.1 mm | 1.5 mm |

It is clear that the use of the SSZZSS web, consisting of both S-twist twisted yarns and Z-twist twisted yarns, results in a significant reduction of the areas without reinforcing yarns in the resulting unidirectional web.

Performances of the Materials According to the Invention

The performance of the materials according to the invention was evaluated, according to the methods described in PART A.

Irrespective of the unidirectional web consisting solely of twisted S-twist or Z-twist yarns, or the unidirectional web consisting of both S-twist and Z-twist twisted yarns, the advantages of using the twisted yarns proposed in the invention remain, in terms of a decrease in the ratio of vacuum thickness to non-vacuum thickness, decrease in overrun, improvement in the transverse permeability of the material, and improvement in the transverse electrical conductivity of the material.

The mechanical performance for materials with a unidirectional web consisting of both S-twist and Z-twist twisted yarns, as proposed within the scope of the invention, is, in contrast, very satisfactory, due to a reduction in defects within the reinforcing materials produced.

The results obtained are presented in Table 12 below:

TABLE 12

| | Comparative | Material 15 |
|---|---|---|
| Material | material 19 | of the invention |
| OHC dry, 23° C. | 263 | 281 |
| Stress MPa | | |
| Unc dry, 23° C. | 533 | 549 |
| Stress MPa | | |

Overrun performances are improved for the unidirectional web consisting of both S-twist twisted yarns and Z-twist twisted yarns, as compared to comparative micro-perforated material 19. Thus, overrun performances are improved whether the material has a unidirectional web consisting of a sequence of yarns twisted in the same direction, or a unidirectional web consisting of a mixture of S-twisted and Z-twisted yarns. The results obtained are presented in Table 13 below.

TABLE 13

| | Comparative | Material 15 |
|---|---|---|
| Material | material 19 | of the invention |
| Ratio of thickness divided by | 1.6 | 1.3 |
| theoretical thickness for 60% FVR | | |

Transverse permeability performance was also measured on material 15 according to the invention and compared to that of comparative material 19, and is presented below in Table 14. The transverse permeabilities obtained are comparable for the two materials.

TABLE 14

| | | Comparative | Material |
|---|---|---|---|
| | | material | 15 of the |
| Material | | 19 | invention |
| Permeability (m²) | 58% FVR | 5.54E−15 | 5.01E−15 |
| | 60% FVR | 4.97E−15 | 4.02E−15 |
| | 62% FVR | 4.15E−15 | 3.21E−15 |

Transverse electrical conductivity performance was also measured on material 15 according to the invention, and is presented in Table 15 below:

TABLE 15

| Material | Material 15 of the invention |
|---|---|
| Transverse electrical conductivity (S/m) | 12.3 |

Material 15 according to the invention provides good electrical properties, especially as compared to those obtained with comparative material 1.

1-21. (canceled)

22. A reinforcement material for use with an infusion resin, comprising:
(a) a web formed from a plurality of carbon fiber yarns, each of said yarns comprising twisted filaments, said yarns each having filaments which have been twisted by between 6 and 12 turns/meter of yarn, said yarns having either a S-twist or a Z-twist;
Said plurality of yarns being arranged together in a planar assembly with all of said yarns aligned in a parallel orientation, with respect to a line bisecting said planar assembly, there being an equal number of yarns having an S-twist on one side of said bisecting line as the other side of said bisecting line and an equal number of yarns having a Z-twist on one side of said bisecting line as the other;
(b) a layer of non-woven polymeric material on each of the top and bottom surfaces of said planar assembly, said polymeric material comprising between 2 to 6% by weight of said reinforcing material.

23. The reinforcement material of claim 22, wherein:
(a) the width of said reinforcement material is between 12 to 51 mm;
(b) the web is between 126 and 210 g/m²; and
(c) the yarns have a titer of 6 to 12K.

24. The reinforcement of claim 23, wherein:
(a) the polymeric layers comprise a porous film, a scrim, a powder coating, a liquid polymer coating, or a veil, or combinations thereof;
(b) the polymeric layers comprise thermoplastic polymers, partially cross-linked thermoplastic polymers, or mixtures thereof; and
(c) the polymeric layers have a basis weight of 0.2 g/m² to 20 g/m² and a thickness of 3 microns to 35 microns.

25. The reinforcement material of claim 24, wherein the yarns of the planar assembly are arranged, with respect to S-Twist and Z-Twist orientation of their filaments in a sequence chosen from the group consisting of: SZZS, SZSZ, SZSZS, SSZZSS, SZSSZS, SZSZSZ, and SSZZSSZZ.

26. The preform comprising a plurality of layers of the reinforcing material of claim 24, said plurality of layers forming a stack suitable for infusion, said stack being assembled without perforation, sewing, knitting, said stack being held together by partial melting of the polymeric layers on the top and bottom surfaces of said layers of reinforcing materials.
